(19) United States
(12) Patent Application Publication
(10) Pub. No.: US 2026/0036726 A1
(43) Pub. Date: Feb. 5, 2026

(54) LIGHT DIFFUSION CONTROL MEMBER AND REFLECTION-TYPE DISPLAY BODY

(71) Applicants: LINTEC CORPORATION, Tokyo (JP); TOHOKU UNIVERSITY, Miyagi (JP)

(72) Inventors: Kentaro KUSAMA, Tokyo (JP); Hiroki FUKUSHIMA, Tokyo (JP); Takahiro ISHINABE, Miyagi (JP); Hideo FUJIKAKE, Miyagi (JP)

(73) Assignees: LINTEC CORPORATION, Tokyo (JP); TOHOKU UNIVERSITY, Miyagi (JP)

(21) Appl. No.: 19/105,873

(22) PCT Filed: Aug. 25, 2023
(86) PCT No.: PCT/JP2023/030732

§ 371 Date: Feb. 24, 2025

(30) Foreign Application Priority Data
Aug. 25, 2022 (JP) 2022-134551

(51) Int. Cl. G02B 5/02

(52) U.S. Cl. CPC G02B 5/0236; G02B 5/0278

(57) ABSTRACT

A light diffusion control member includes a light diffusion control layer having a regular internal structure that includes a plurality of regions having a relatively high refractive index in a region having a relatively low refractive index, and a diffusion pressure sensitive adhesive layer containing light-diffusing fine particles. L₁, L₂, and L₃ identified from reflected light measured for the light diffusion control member (1a, 1b) satisfy the following expressions: (1) L₁>1.00; (2) 0.70≤L₂≤1.00; and (3) L₃<2.00.

### TECHNICAL FIELD

The present invention relates to a light diffusion control member including a light diffusion control layer that can transmit and diffuse the incident light within a predetermined incident angle range in a strong and low light loss state and relates also to a reflective display body including the light diffusion control member.

### BACKGROUND ART

Display bodies such as liquid crystal display devices, organic electroluminescence (EL) displays, and electronic paper include those classified into reflective display bodies including reflective layers. In such reflective display bodies, the display surface of a reflective display body is generally illuminated by a light source such as an indoor light or the sun and/or a light source provided on the display surface side of the display body, and light from these light sources is reflected by the reflective layer into reflected light, which enables good visibility of the display.

When using the reflective display body, the positional relationship between the light source and the viewer is usually not fixed due to the use of an external light source. This may result in a problem in that, depending on the position of the light source, insufficient light reaches the viewer to deteriorate the visibility and the entire display body cannot be illuminated brightly. To solve such a problem, for example, it is conceivable to incorporate a light diffusion plate into the display body. However, simply incorporating a general light diffusion plate may lead to another problem in that the light diffusivity necessary for good visibility cannot be sufficiently obtained and, if attempting to achieve light diffusion at a high level, light loss due to stray light or backscattering occurs to impair the image clarity. From the viewpoint of solving these problems, in the reflective display bodies, it is considered that a light diffusion control layer that can transmit and diffuse the incident light within a predetermined incident angle range in a strong and low light loss state is provided between the surface on the viewer side and the reflective layer.

For example, Patent Documents 1 and 2 disclose light diffusion control members each including the above light diffusion control layer and an isotropic light diffusion layer containing light-diffusing fine particles. In such a light diffusion control member, the existence of the above light diffusion control layer allows the light reflected from the reflective layer to be moderately diffused, and the deterioration in the visibility depending on the position of the light source can thus be reduced.

### PRIOR ART DOCUMENTS

### Patent Documents

[Patent Document 1] JP6981984B
[Patent Document 2] JP6993976B

### SUMMARY OF THE INVENTION

### Problems to be Solved by the Invention

Meanwhile, many smartphones and tablets in recent years have a function of switching the up-down direction of display content in accordance with the vertical posture of the display surface. That is, when the short sides of the display surface are parallel to the ground, the display content is displayed such that the up-down direction of the display content is parallel to the long sides of the display surface, while when the long sides of the display surface are parallel to the ground, the display content is displayed such that the up-down direction of the display content is parallel to the short sides of the display surface.

In such a reflective display body configured such that the up-down direction of display content on the display surface can be changed, there is a problem in that the effect of improving visibility by the above-described light diffusion control layer cannot be fully obtained when the up-down direction of the display content is changed. For example, even though good visibility is obtained when the short sides of the display surface are parallel to the ground and the display content is displayed such that the up-down direction of the display content is parallel to the long sides of the display surface, when the long sides of the display surface are parallel to the ground and the display content is displayed such that the up-down direction of the display content is parallel to the short sides of the display surface, the light diffusion control layer cannot fully exert its effect and sufficient visibility cannot be obtained.

The present invention has been made in consideration of such actual circumstances and an object of the present invention is to provide a light diffusion control member that can achieve excellent visibility regardless of the up-down direction of the display content even when incorporated into a reflective display body in which the up-down direction of the display content is changed. Another object of the present invention is to provide a reflective display body having such visibility.

### Means for Solving the Problems

To achieve the above objects, first, the present invention provides a light diffusion control member comprising: a light diffusion control layer having a regular internal structure that includes a plurality of regions having a relatively high refractive index in a region having a relatively low refractive index; and a diffusion pressure sensitive adhesive layer that is laminated on one surface side of the light diffusion control layer and contains light-diffusing fine particles, wherein, provided that: an arbitrary point on a surface on the light diffusion control member side of a measurement sample obtained by laminating an arbitrary surface of the light diffusion control member on a reflective surface of an arbitrary mirror is irradiated with a light ray having an angle of 30° with respect to a normal to the surface from each of four directions of azimuth angles of 0°, 90°, 180°, and 270° with the point as a center to generate reflected light that is diffused and reflected from the point for each of the azimuth angles, for the reflected light that travels within a plane including the point and the normal and forms an angle of 30° or less with the normal, a value of a standard deviation (cd/m²) of luminance is calculated for each of the azimuth angles, and the azimuth angle that gives a largest standard deviation is defined as an exclusion angle; an arbitrary point on the surface on the light diffusion control member side of the measurement sample is irradiated with a light ray having an angle of 30° with respect to the normal to the surface from each of three directions of azimuth angles excluding the exclusion angle out of the four directions of azimuth angles to generate reflected light that is diffused and reflected from the point for each of the three directions of azimuth angles, luminance (cd/m²) of the reflected light that travels in a front direction of the surface is measured for each of the three directions of azimuth angles, and a minimum luminance value of the three obtained luminance values is defined as Lₘᵢₙ while a maximum luminance value is defined as Lₘₐₓ; and an arbitrary point on one surface of any standard white plate is irradiated with a light ray having an angle of 30° with respect to the normal from the azimuth angle, at which the Lₘᵢₙ is measured, to generate reflected light that is diffused and reflected from the point in the front direction, and a value of luminance (cd/m²) of the reflected light is defined as L_{STD},
L₁ represented by L₁=Lₘᵢₙ/L_{STD} satisfies Expression (1) below

$${L}_{1} > 1 \text{.00} , \qquad ( 1 )$$

L₂ represented by L₂=Lₘᵢₙ/Lₘₐₓ satisfies Expression (2) below

$$0.7 \leq {L}_{2} \leq 1. , \qquad ( 2 )$$

when values of standard deviations (cd/m²) relating to the three directions of azimuth angles excluding the exclusion angle out of the four directions of azimuth angles are L₃, L₃ in all the three directions satisfies Expression (3) below

$$\begin{matrix}( Invention 1 ) & \\ {L}_{3} < 2. . & ( 3 )\end{matrix}$$

The light diffusion control member according to the above invention (Invention 1) includes the light diffusion control layer and the diffusion pressure sensitive adhesive layer and satisfies the above-described conditions of L₁, L₂, and L₃, so that when incorporated in a reflective display body in which the up-down direction of the display content is changed, the light diffusion control member can achieve uniform and good brightness even if the up-down direction of the display content is changed, and as a result, excellent visibility can be achieved.

In the above invention (Invention 1), preferably, the regions having a relatively high refractive index may be columnar bodies extending from one surface side to another surface side of the light diffusion control layer, the light diffusion control layer may include at least one layer formed of a column structure configured such that the columnar bodies are densely arranged to stand in the region having a relatively low refractive index, and a straight line parallel to a direction of the extension may be tilted with respect to a thickness direction of the light diffusion control layer in at least some of the columnar bodies (Invention 2).

In the above invention (Invention 2), preferably, the columnar bodies may be bent between one end and another end in at least one layer formed of the column structure (Invention 3).

In the above invention (Invention 2), preferably, the light diffusion control layer may include two layers each formed of the column structure (Invention 4).

In the above invention (Invention 1), preferably, the light diffusion control layer may include an intermediate pressure sensitive adhesive layer laminated between the light diffusion control layer and the diffusion pressure sensitive adhesive layer, and the intermediate pressure sensitive adhesive layer may be composed of a pressure sensitive adhesive containing a carboxy group (Invention 5).

In the above invention (Invention 1), preferably, the light-diffusing fine particles may be fine particles composed of a silicon-containing compound having an intermediate structure between inorganic one and organic one (Invention 6).

Second, the present invention provides a reflective display body configured such that an up-down direction of a display content on a display surface can be changed, the reflective display body comprising: the light diffusion control member (Invention 1); a display device provided on any one surface side of the light diffusion control member; and a reflective layer that is provided on a surface side of the display device opposite to the light diffusion control member or that is incorporated in the display device (Invention 7).

### Advantageous Effect of the Invention

According to the light diffusion control member of the present invention, it is possible to realize a reflective display body that can achieve excellent visibility regardless of the up-down direction of the display content.

### BRIEF DESCRIPTION OF DRAWINGS

FIG. 1 is a cross-sectional view of a light diffusion control member according to an embodiment of the present invention.

FIG. 2 is a cross-sectional view of a light diffusion control member according to another embodiment of the present invention.

FIG. 3 is a cross-sectional view of an example of a reflective display body manufactured using a light diffusion control member according to an embodiment of the present invention.

FIG. 4 is a set of perspective views each schematically illustrating an example of a regular internal structure (column structure) of a light diffusion control layer in an embodiment of the present invention.

FIG. 5 is a perspective view illustrating various directions related to a light diffusion control layer in an embodiment of the present invention.

FIG. 6 is a set of diagrams for explaining a method of measuring the optical properties of a light diffusion control member according to an embodiment of the present invention.

FIG. 7 is a set of diagrams illustrating a method of measuring the optical properties of a light diffusion control member according to an embodiment of the present invention.

### EMBODIMENTS FOR CARRYING OUT THE INVENTION

Hereinafter, one or more embodiments of the present invention will be described.

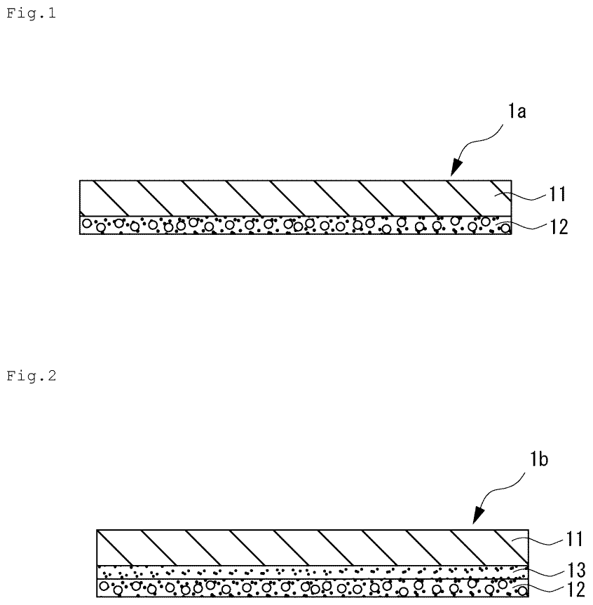

FIG. 1 illustrates a cross-sectional view of a light diffusion control member according to an embodiment of the present invention. As illustrated in FIG. 1, light diffusion control member 1a includes a light diffusion control layer 11 having a regular internal structure that includes a plurality of regions having a relatively high refractive index in a region having a relatively low refractive index, and a diffusion pressure sensitive adhesive layer 12 that is laminated on one surface side of the light diffusion control layer 11 and contains light-diffusing fine particles.

FIG. 2 illustrates a cross-sectional view of a light diffusion control member according to another embodiment of the present invention. As illustrated in FIG. 2, light diffusion control member 1b includes a light diffusion control layer 11 and a diffusion pressure sensitive adhesive layer 12 as in the light diffusion control member 1a, and further includes an intermediate pressure sensitive adhesive layer 13 laminated between the light diffusion control layer 11 and the diffusion pressure sensitive adhesive layer 12.

The form of the light diffusion control member 1a, 1b according to the present embodiment is not particularly limited, but may be preferably a film or plate shape or the like and may be particularly preferably a film shape.

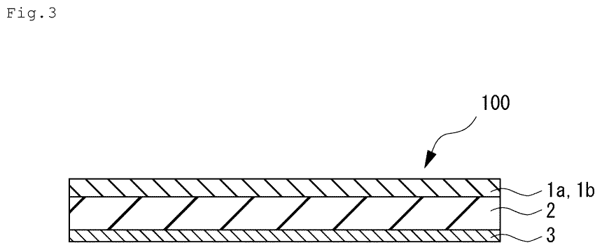

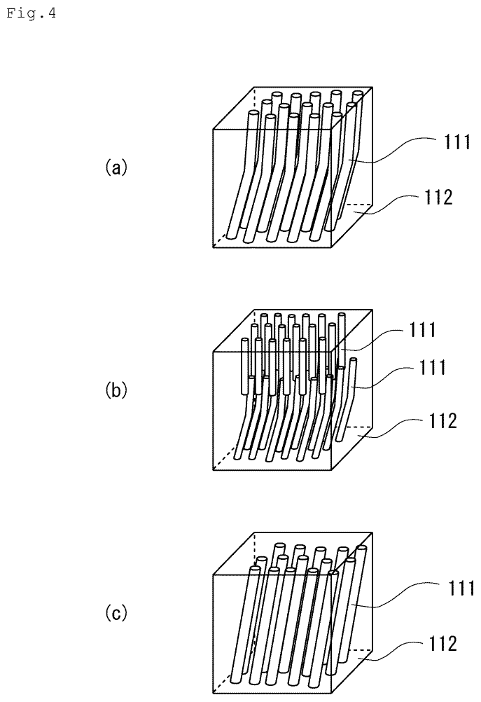

The light diffusion control member 1a, 1b according to the present embodiment can be suitably used in the manufacture of a reflective display body. FIG. 3 illustrates a cross-sectional view of an example of such a reflective display body. Reflective display body 100 includes the above-described light diffusion control member 1a, 1b, a display device 2 provided on one surface side of the light diffusion control member 1a, 1b, and a reflective layer 3 provided on the surface side of the display device 2 opposite to the light diffusion control member 1a, 1b. Here, which surface of the light diffusion control member 1a, 1b (the surface on the light diffusion control layer 11 side or the surface on the diffusion pressure sensitive adhesive layer 12 side) should be laminated to the display device 2 and the reflective layer 3 can be appropriately selected depending on the configuration of the reflective display body 100 to be manufactured. Preferably, the reflective display body 100 according to the present embodiment may be configured such that the up-down direction of the display content on the display surface can be changed.

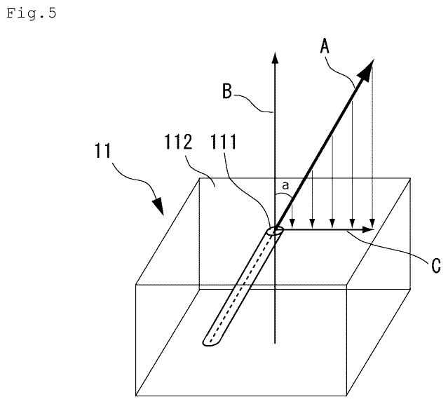

In the light diffusion control member 1a, 1b according to the present embodiment, the light diffusion control layer 11 has a regular internal structure that includes a plurality of regions having a relatively high refractive index in a region having a relatively low refractive index, as described above. As an example of such a regular internal structure, FIG. 4 schematically illustrates a column structure (described in detail later). As illustrated in FIGS. 4(a) to (c), the light diffusion control layer 11 has a structure in which a plurality of regions 111 (columnar bodies) having a relatively high refractive index extend in the thickness direction and the surroundings are filled with a region 112 having a relatively low refractive index. Here, the regular internal structure refers to an internal structure configured such that the plurality of regions 111 having a relatively high refractive index are arranged with a predetermined regularity in the region 112 having a relatively low refractive index. Such an internal structure refers, for example, to an internal structure configured such that, when viewing a cross section obtained by cutting the light diffusion control layer 11 along a plane parallel to the surface of the light diffusion control layer 11 at a position where the regular internal structure exists, the regions 111 having a relatively high refractive index are repeatedly arranged at a similar pitch along at least one direction in the above cross section in the region 112 having a relatively low index. Thus, the regular internal structure as referred to herein has a feature that the regions 111 having a relatively high refractive index extend in the thickness direction of the light diffusion control layer 11, and this feature is distinguished from those of a phase-separation structure in which one phases exist in the other phase without clear regularity or a sea-island structure in which approximately spherical island components exist in a sea component. The differences in the structures illustrated in FIGS. 4(a) to (c) will be described in detail later.

The light diffusion control member 1a, 1b according to the present embodiment satisfies predetermined optical characteristics when its surface on the light diffusion control layer 11 side is irradiated with light rays to generate reflected light that is diffused and reflected. The optical characteristics will be described below.

First, a measurement method performed for specifying the above-described optical characteristics will be described. FIG. 6 illustrates steps of preparing a measurement sample and irradiating the obtained measurement sample with predetermined light rays. At the beginning, as illustrated in FIG. 6(a), a measurement sample 200 is prepared by laminating any one surface of the light diffusion control member 1a, 1b onto the reflective surface of a mirror 4. Subsequently, as illustrated in FIG. 6(b) (a plan view of the measurement sample 200 from the surface on the light diffusion control member 1 side), an arbitrary point on the surface on the light diffusion control member 1a, 1b side of the measurement sample 200 is assumed to be an irradiation point 201, and four directions of azimuth angles of 0°, 90°, 180°, and 270° are assumed with the irradiation point 201 as the center. Then, as illustrated in FIG. 6(c), the irradiation point 201 is irradiated with a light ray 202 having an angle of 30° with respect to the normal to the surface on the light diffusion control member 1 side from one of the four azimuth angles described above.

When laminating the light diffusion control member 1a, 1b on the mirror 4, any surface of the light diffusion control member 1a, 1b may be laminated on the mirror 4, but it may be preferred to match the orientation with respect to the reflective layer 3 when constructing the reflective display body 100. That is, when laminating the surface on the light diffusion control layer 11 side of the light diffusion control member 1a, 1b on the reflective layer 3, it may be preferred to form the measurement sample 200 by laminating that surface on the mirror 4. On the other hand, when laminating the surface on the diffusion pressure sensitive adhesive layer 12 side of the light diffusion control member 1a, 1b on the reflective layer 3, it may be preferred to form the measurement sample 200 by laminating that surface on the mirror 4.

As used in the present specification, the “mirror” refers to a mirror formed by laminating a metal film on one surface side of a glass plate, and the “reflective surface” of the mirror refers to the surface of the metal film opposite to the glass plate. Examples of metal constituting the metal film include aluminum and silver.

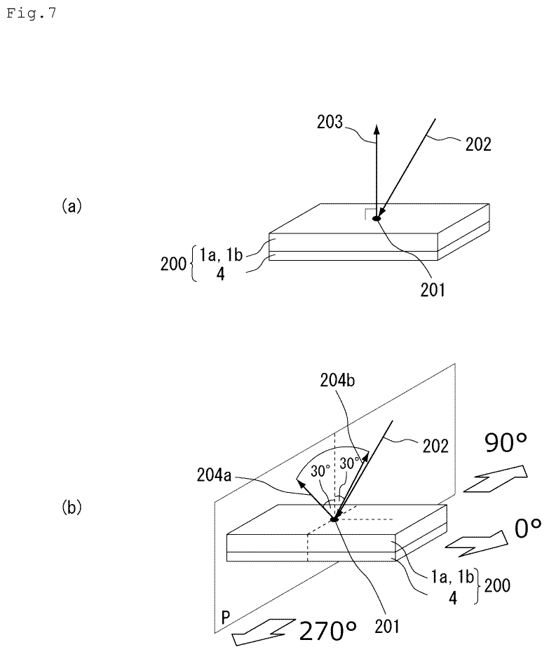

The irradiated light ray 202 is diffused and reflected by the measurement sample 200, which generates reflected light. When acquiring the optical characteristics of the light diffusion control member 1a, 1b, the luminance of a portion of the reflected light generated is measured. There are two types of reflected light that are the subject of such measurement, which will be explained using FIG. 7.

FIG. 7(a) illustrates the first subject of measurement. As illustrated in the figure, in the reflected light resulting from the diffuse reflection of the light ray 202, reflected light 203 that travels from the irradiation point 201 in the normal direction (front direction) of the surface on the light diffusion control member 1a, 1b side is the first subject of measurement.

FIG. 7(b) illustrates the second subject of measurement. First, as illustrated in the figure, a plane P is assumed that includes the irradiation point 201 and the normal to the surface on the light diffusion control member 1a, 1b side and is perpendicular to the azimuth angle (0° in FIG. 7(b)) at which the sample is irradiated with the light ray 202 (i.e., parallel to the azimuth angles of 90° and 270° in FIG. 7(b)). Then, in the reflected light resulting from the diffuse reflection of the light ray 202, reflected light that travels within the above plane P and forms an angle of 30° or less with the above normal (a collection of reflected light that forms a fan shape with reflected light 204a and reflected light 204b as ends in FIG. 7(b)) is the second subject of measurement.

Next, the concepts of “exclusion angle,” “Lₘᵢₙ,” “Lₘₐₓ” and “L_{STD}” that are necessary to specify the aforementioned optical characteristics will be explained in order.

The “exclusion angle” refers to an angle that is specified as follows. First, the measurement sample prepared as described previously is irradiated with a light ray as described previously to generate reflected light relating to the aforementioned second subject of measurement (a collection of reflected light that forms a fan shape with the reflected light 204a and the reflected light 204b as ends in FIG. 7(b)) for each of four directions of azimuth angles of 0°, 90°, 180°, and 270°. Then, for the reflected light, the standard deviation (cd/m²) of the luminance is calculated for each of the above azimuth angles. In the four standard deviations thus obtained, the azimuth angle that gives the largest standard deviation is the “exclusion angle.”

Next, “Lₘᵢₙ” and “Lₘₐₓ” are specified as follows. First, the measurement sample prepared as described previously is irradiated with light as described previously to generate reflected light relating to the aforementioned first subject of measurement (the reflected light 203 that travels in the normal direction (front direction) of the surface on the light diffusion control member 1a, 1b side, as illustrated in FIG. 6(c)), and its luminance (cd/m²) is measured. Here, the azimuth angles when irradiating the sample with the light rays are limited to only three directions excluding the above “exclusion angle” from the four azimuth angles of 0°, 90°, 180°, and 270°. Then, the minimum luminance value of the three obtained luminance values is defined as “Lₘᵢₙ,” and the maximum luminance value is defined as “Lₘₐₓ.”

Finally, “L_{STD}” is the standard luminance measured using any standard white plate. Specifically, an arbitrary point on one surface of any standard white plate is irradiated with a light ray having an angle of 30° with respect to the normal from the azimuth angle, at which the above Lₘᵢₙ is measured, to generate reflected light that is diffused and reflected from the above point in the front direction. Then, “L_{STD}” is specified as the value of luminance (cd/m²) of the reflected light. In the present specification, the “standard white plate” refers to a reflective plate with a reflectance of 99% or more. The “standard white plate” serves as the calibration standard for optical measurements. By using the “standard white plate,” it is possible to cancel variations in the intensity of the measurement light, etc., caused by differences in light sources.

In the above cases, the light diffusion control member 1a, 1b according to the present embodiment may be preferably such that L₁ represented by L₁=Lₘᵢₙ/L_{STD} satisfies Expression (1) below

$${L}_{1} > 1 \text{.00} . \qquad ( 1 )$$

By satisfying Expression (1), the light diffusion control member 1a, 1b according to the present embodiment can obtain a higher luminance than the luminance (L_{STD}) at the time of diffusion (Lambertian diffusion) occurring on a standard white plate, even in the lowest luminance (Lₘᵢₙ). Accordingly, in a reflective display body incorporating the light diffusion control member 1a, 1b, it becomes easier to achieve a brighter display using light with which the display surface is irradiated from various azimuth angles. From this viewpoint, L₁ may be preferably 1.10 or more, more preferably 1.20 or more, particularly preferably 1.30 or more, further preferably 1.40 or more, and most preferably 1.45 or more. The upper limit of L₁ is not particularly limited, but may be preferably 4.00 or less, for example, more preferably 3.00 or less, particularly preferably 2.00 or less, further preferably 1.60 or less, and especially preferably 1.50 or less.

Additionally or alternatively, the light diffusion control member 1a, 1b according to the present embodiment may be preferably such that L₂ represented by L₂=Lₘᵢₙ/Lₘₐₓ satisfies Expression (2) below

$$0.7 \leq {L}_{2} \leq 1. . \qquad ( 2 )$$

By satisfying Expression (2), the light diffusion control member 1a, 1b according to the present embodiment may have a relatively small difference between the lowest luminance (Lₘᵢₙ) and the highest luminance (Lₘₐₓ). Accordingly, in a reflective display body incorporating the light diffusion control member 1, even when the reflective display body is turned sideways and the positional relationship between the display surface and the external light source is changed, the change in the brightness of the display can be suppressed, and it is easy to achieve uniform brightness. From this viewpoint, L₂ may be particularly preferably 0.71 or more and further preferably 0.72 or more. The upper limit of L₂ is not particularly restricted, provided that it is 1.00 or less, but from the viewpoint of compatibility with L₃ described later, it may be preferably 0.95 or less, more preferably 0.90 or less, particularly preferably 0.85 or less, further preferably 0.80 or less, especially preferably 0.76 or less, and most preferably 0.73 or less.

Additionally or alternatively, when values of standard deviations relating to the three directions of azimuth angles excluding the above-described exclusion angle out of the aforementioned standard deviations are L₃, L₃ in all the three directions may preferably satisfy Expression (3) below

$${L}_{3} < 2 \text{.00} . \qquad ( 3 )$$

By satisfying Expression (3), regardless of the direction from which the light diffusion control member 1a, 1b according to the present embodiment is irradiated with light, the reflective display body incorporating the light diffusion control member 1a, 1b can well diffuse and reflect uniform light in the horizontal direction toward the viewer. Accordingly, the viewer can view the display with the same luminance with the right eye and the left eye, and is less likely to recognize unevenness in brightness. From this viewpoint, L₃ may be preferably 1.6 or less, more preferably 1.2 or less, particularly preferably 1.1 or less, and further preferably 1.05 or less. The lower limit of L₃ is not particularly limited, but may be preferably 0.01 or more, for example, more preferably 0.1 or more, and particularly preferably 0.15 or more.

In the conventional reflective display body, there are problems in that when the reflective display body is turned sideways to change the up-down direction of the display content, for example, the light irradiating the display body from above is not sufficiently diffused or reflected in the front direction and the brightness of the display varies greatly with the change in the direction of irradiation.

In contrast, the light diffusion control member 1a, 1b according to the present embodiment satisfies the above-described conditions of L₁, L₂, and L₃, and the reflective display body incorporating the light diffusion control member 1a, 1b can thereby have excellent visibility. Specifically, as compared to a case in which the light diffusion control member 1a, 1b is not provided, the light irradiating the display body from the outside can be effectively diffused and reflected in the front direction, and a bright display can be achieved. Moreover, even when the reflective display body is turned sideways and the up-down direction of the display content is thereby changed, for example, the variation in the brightness of the display caused by the change in the up-down direction can be suppressed, and a display of uniform brightness can be achieved. Furthermore, even when the direction of the light irradiating the display body from the outside changes, the light can be diffused and reflected with uniform brightness in the horizontal direction toward the viewer, and the viewer is less likely to recognize unevenness in brightness.

The details of the measurement method for the above luminance are as described in the testing example, which will be described later.

### 1. Light Diffusion Control Layer

The light diffusion control layer 11 in the present embodiment is not particularly limited, provided that it has a regular internal structure that includes a plurality of regions 111 having a relatively high refractive index in a region 112 having a relatively low refractive index and it allows the aforementioned conditions of L₁, L₂, and L₃ to be satisfied.

From the viewpoint of easily forming the regular above and readily internal structure as described satisfying the aforementioned conditions of L₁, L₂, and L₃, the light diffusion control layer 11 in the present embodiment may be preferably obtained by curing a composition for light diffusion control layer that contains a high refractive index component and a low refractive index component having a refractive index lower than that of the high refractive index component. In particular, each of the high refractive index component and the low refractive index component may preferably have one or two polymerizable functional groups.

### (1) High Refractive Index Component

Preferred examples of the high refractive index component include (meth)acrylic ester that contains an aromatic ring, and (meth)acrylic ester that contains a plurality of aromatic rings may be particularly preferred. Examples of (meth)acrylic ester that contains a plurality of aromatic rings include those in which a part thereof is substituted with halogen, alkyl, alkoxy, alkyl halide, or the like, such as biphenyl (meth)acrylate, naphthyl (meth)acrylate, anthracyl (meth)acrylate, benzylphenyl (meth)acrylate, biphenyloxyalkyl (meth)acrylate, naphthyloxyalkyl (meth)acrylate, anthracyloxyalkyl (meth)acrylate, and benzylphenyloxyalkyl (meth)acrylate. Among these, biphenyl (meth)acrylate may be preferred from the viewpoint of easily forming a good regular internal structure and readily satisfying the aforementioned conditions of L₁, L₂, and L₃. Specifically, o-phenylphenoxyethyl acrylate, o-phenylphenoxyethoxyethyl acrylate, or the like may be preferred. In the present specification, (meth)acrylic acid means both the acrylic acid and the methacrylic acid. The same applies to other similar terms.

The molecular weight of the high refractive index component may be preferably 150 to 2, 500, particularly preferably 200 to 1,500, and further preferably 250 to 1,000. When the molecular weight falls within the above the light diffusion control layer 11 having a range, desired regular internal structure can be easily formed, and the aforementioned conditions of L₁, L₂, and L₃ can be readily satisfied. When the theoretical molecular weight of the above high refractive index component can be specified based on the molecular structure, the molecular weight of the high refractive index component refers to the theoretical molecular weight. On the other hand, when it is difficult to specify the above-described theoretical molecular weight due to the above high refractive index component being a polymer component, for example, the molecular weight of the high refractive index component refers to a weight-average molecular weight obtained as a standard polystyrene-equivalent value that is measured using a gel permeation chromatography (GPC) method. As used in the present the weight-average molecular weight refers to a value that is measured as the standard polystyrene equivalent value using the GPC method.

The refractive index of the high refractive index component may be preferably 1.45 to 1.70, more preferably 1.50 to 1.65, particularly preferably 1.54 to 1.62, and further preferably 1.56 to 1.59. When the refractive index falls within the above range, the light diffusion control layer 11 having a desired regular internal structure can be easily formed, and the aforementioned conditions of L₁, L₂, and L₃ can be readily satisfied. As used in the present specification, the refractive index means the refractive index of a certain component before curing the composition for light diffusion control layer, and the refractive index is measured in accordance with JIS K0062: 1992.

The content of the high refractive index component in the composition for light diffusion control layer may be preferably 25 to 400 mass parts, more preferably 50 to 350 mass parts, particularly preferably 75 to 300 mass parts, and further preferably 100 to 200 mass parts with respect to 100 mass parts of the low refractive index component. When the content falls within the above range, the regions derived from the high refractive index component and the region derived from the low refractive index component exist with a desired ratio in the regular internal structure of the light diffusion control layer 11 formed, so that a desired regular internal structure can be easily formed, and the aforementioned conditions of L₁, L₂, and L₃ can be readily satisfied.

### (2) Low Refractive Index Component

Preferred examples of the low refractive index component include urethane (meth)acrylate, a (meth)acrylic-based polymer having a (meth)acryloyl group in a side chain, a (meth)acryloyl group-containing silicone resin, and an unsaturated polyester resin. Among them, it may be particularly preferred to use urethane (meth)acrylate from the viewpoints that a good regular internal structure can be easily formed, and the aforementioned conditions of L₁, L₂, and L₃ can be readily satisfied. More specifically, it may be preferred to use urethane (meth)acrylate that is formed of (a) a compound containing at least two isocyanate groups, (b) polyalkylene glycol, and (c) hydroxyalkyl (meth)acrylate.

Preferred examples of the above-described (a) compound containing at least two isocyanate groups include aromatic polyisocyanates such as 2,4-tolylene diisocyanate, 2,6-tolylene diisocyanate, 1,3-xylylene diisocyanate, and 1,4-xylylene diisocyanate, aliphatic polyisocyanates such as hexamethylene diisocyanate, alicyclic polyisocyanates such as isophorone diisocyanate and hydrogenated diphenylmethane diisocyanate, biuret bodies and isocyanurate bodies thereof, and adduct bodies that are reaction products with low molecular active hydrogen-containing compounds such as ethylene glycol, propylene glycol, neopentyl glycol, trimethylol propane, and castor oil. Among these, an alicyclic polyisocyanate may be preferred, and an alicyclic diisocyanate may be particularly preferred.

Preferred examples of the above-described (b) polyalkylene glycol include polyethylene glycol, polypropylene glycol, polybutylene glycol, and polyhexylene glycol, among which polypropylene glycol may be preferred. The weight-average molecular weight of the (b) polyalkylene glycol may be preferably 2,300 to 19, 500, particularly preferably 3,000 to 14,300, and further preferably 4,000 to 12,300.

Preferred examples of the above-described (c) hydroxyalkyl (meth)acrylate include 2-hydroxyethyl (meth)acrylate, 2-hydroxypropyl (meth)acrylate, 3-hydroxypropyl (meth)acrylate, 2-hydroxybutyl (meth)acrylate, 3-hydroxybutyl (meth)acrylate, and 4-hydroxybutyl (meth)acrylate, among which 2-hydroxyethyl (meth)acrylate may be preferred.

Synthesis of the urethane (meth)acrylate using the above-described components (a) to (c) as the materials can be performed in a commonly-used method. In such a method, from the viewpoint of efficiently synthesizing the urethane (meth)acrylate, the compounding ratio of the components (a), (b), and (c) as the molar ratio may be preferably a ratio of 1-5:1:1-5 and particularly preferably a ratio of 1-3:1:1-3.

The weight-average molecular weight of the low refractive index component may be preferably 3,000 to 20,000, particularly preferably 5,000 to 15,000, and further preferably 7,000 to 13,000. When the weight-average molecular weight falls within the above range, the light diffusion control layer 11 having a desired regular internal structure can be easily formed, and the aforementioned conditions of L₁, L₂, and L₃ can be readily satisfied.

The refractive index of the low refractive index component may be preferably 1.30 to 1.59, more preferably 1.38 to 1.50, particularly preferably 1.42 to 1.49, and further preferably 1.46 to 1.48. When the refractive index falls within the above range, the light diffusion control layer 11 having a desired regular internal structure can be easily formed, and the aforementioned conditions of L₁, L₂, and L₃ can be readily satisfied.

### (3) Other Additives

The aforementioned composition for light diffusion control layer may contain other additives in addition to the high refractive index component and the low refractive index component. Examples of other additives include a multifunctional monomer (compound having three or more polymerizable functional groups), a photopolymerization initiator, an antioxidant, an ultraviolet absorber, a light stabilizer, an antistatic, a polymerization accelerator, a polymerization inhibitor, an infrared absorber, a plasticizer, a diluting solvent, and a leveling agent.

### (3-1) Photopolymerization Initiator

The composition for light diffusion control layer may preferably contain a photopolymerization initiator as one of the other additives. This allows the light diffusion control layer 11 having a desired regular internal structure to be easily and efficiently formed and also allows the aforementioned conditions of L₁, L₂, and L₃ to be readily satisfied.

Examples of the photopolymerization initiator include benzoin, benzoin methyl ether, benzoin ethyl ether, benzoin isopropyl ether, benzoin-n-butyl ether, benzoin isobutyl ether, acetophenone, dimethylaminoacetophenone, 2,2-dimethoxy-2-phenylacetophenone, 2,2-diethoxy-2-phenylacetophenone, 2-hydroxy-2-methyl-1-phenylpropan-1-one, 1-hydroxycyclohexyl phenyl ketone, 2-methyl-1-[4-(methylthio)phenyl]-2-morpholino-propan-1-one, 4-(2-hydroxyethoxy)phenyl-2-(hydroxy-2-propyl)ketone, benzophenone, p-phenylbenzophenone, 4,4-diethylaminobenzophenone, dichlorobenzophenone, 2-methylanthraquinone, 2-ethylanthraquinone, 2-tert-butylanthraquinone, 2-aminoanthraquinone, 2-methylthioxanthone, 2-ethylthioxanthone, 2-chlorothioxanthone, 2,4-dimethylthioxanthone, 2,4-diethylthioxanthone, benzyl dimethyl ketal, acetophenone dimethyl ketal, p-dimethylaminebenzoic ester, and oligo[2-hydroxy-2-methyl-1-[4-(1-methylvinyl)phenyl]propane]. These may each be used alone, or two or more types may also be used in combination.

When the photopolymerization initiator is used, the content of the photopolymerization initiator in the composition for light diffusion control layer may be preferably 0.2 to 20 mass parts or 0.5 to 16 mass parts, particularly preferably 1 to 13 mass parts, and further preferably 1 to 10 mass parts with respect to 100 mass parts of the total amount of the high refractive index component and the low refractive index component. When the content falls within the above range, the light diffusion control layer 11 having a desired regular internal structure can be easily and efficiently formed, and the aforementioned conditions of L₁, L₂, and L₃ can be readily satisfied.

### (3-2) Ultraviolet Absorber

The composition for light diffusion control layer may also preferably contain an ultraviolet absorber as one of the other additives. In the case of containing an ultraviolet absorber, when the coating film of the composition for light diffusion control layer is irradiated with active energy rays, the ultraviolet absorber selectively absorbs active energy rays of a predetermined wavelength within a predetermined range. By optimizing the type and amount of the ultraviolet absorber, it becomes easier to create bending in the formed regions 111 (columnar bodies) having a relatively high refractive index without inhibiting the curing of the composition for light diffusion control layer. As a result, the light diffusion control layer 11 can achieve a wider range of light diffusion angles, and the aforementioned conditions of L₁, L₂, and L₃ can be more readily satisfied.

Examples of ultraviolet absorbers include benzotriazole-based ultraviolet absorbers, hydroxyphenyltriazine-based ultraviolet absorbers, benzophenone-based ultraviolet absorbers, and hydroxybenzoate-based ultraviolet absorbers, among which benzotriazole-based ultraviolet absorbers may be preferably used. One type of the above-described ultraviolet absorbers may be used alone, or two or more types may also be used in combination.

When an ultraviolet absorber is used, the content of the ultraviolet absorber in the composition for light diffusion control layer may be preferably 0.001 to 10 mass parts, more preferably 0.01 to 1 mass part, particularly preferably 0.03 to 0.5 mass parts, and further preferably 0.06 to 0.1 mass parts with respect to 100 mass parts of the total amount of the high refractive index component and the low refractive index component. When the content of the ultraviolet absorber falls within the above range, bending can be efficiently created in the regions 111 (columnar bodies) having a relatively high refractive index. As a result, the light diffusion control layer 11 can achieve a wider range of light diffusion angles, and the aforementioned conditions of L₁, L₂, and L₃ can be more readily satisfied.

### (4) Preparation of Composition for Light Diffusion Control Layer

The composition for light diffusion control layer can be prepared by uniformly mixing the aforementioned high refractive index component and low refractive index component and, if desired, other additives such as a photopolymerization initiator and an ultraviolet absorber.

In the above mixing, a uniform composition for light diffusion control layer may be obtained by stirring it while heating it to a temperature of 40° C. to 80° C. A diluting solvent may be added and mixed so that the obtained composition for light diffusion control layer has a desired viscosity.

### (5) Regular Internal Structure

As described previously, the light diffusion control layer 11 in the present embodiment has a regular internal structure that includes a plurality of regions 111 having a relatively high refractive index in a region 112 having a relatively low refractive index. Examples of the regular internal structure include the aforementioned column structure and a louver structure in which a plurality of plate-like regions having different refractive indices are alternately arranged in one arbitrary direction along the film surface.

In the light diffusion control layer 11 in the present embodiment, the regular internal structure may be preferably a column structure from the viewpoint that the aforementioned conditions of L₁, L₂, and L₃ can be readily satisfied. More specifically, in the light diffusion control layer 11 in the present embodiment, the regions having a relatively high refractive index may be preferably columnar bodies 111 extending from one surface side to the other surface side of the light diffusion control layer 11, and the light diffusion control layer 11 may preferably include at least one layer formed of a column structure configured such that the columnar bodies 111 are densely arranged to stand in a region having a relatively low refractive index. FIG. 4 is a perspective view schematically illustrating such a column structure.

When light incident on the light diffusion control layer 11 having such a column structure falls within a predetermined incident angle range, the light exits the light diffusion control layer 11 while being strongly diffused with a predetermined opening angle. On the other hand, when the incident light falls outside the above incident angle range, the incident light transmits through the light diffusion control layer 11 without being diffused or exits the light diffusion control layer 11 with weaker diffusion than that in the case of the incident light within the incident angle range. When an image creating body is arranged parallel to the surface of the light diffusion control layer 11, the diffused light caused by the incident light within the above incident angle range through the column structure is in a circular shape or an approximately circular shape (such as an elliptical shape) spreading in any direction. On the other hand, in the case of the above weak diffusion due to the incident light outside the above incident angle range, the diffused light is in a crescent shape.

Furthermore, in the light diffusion control layer 11 in the present embodiment, from the viewpoint that the aforementioned conditions of L₁, L₂, and L₃ can be readily satisfied, the straight line parallel to the direction of that extension may be preferably tilted with respect to the thickness direction of the light diffusion control layer 1a, 1b in at least some of the columnar bodies 111. All three types of column structures illustrated in FIG. 4 are tilted. The column structure illustrated in FIG. 4(b) has a form in which the columnar bodies 111, which are densely arranged to stand, are stacked in two layers, and the columnar bodies 111 stand almost vertically in one layer (the upper layer on the paper surface) while the columnar bodies 111 stand tilted in the other layer (the lower layer on the paper surface).

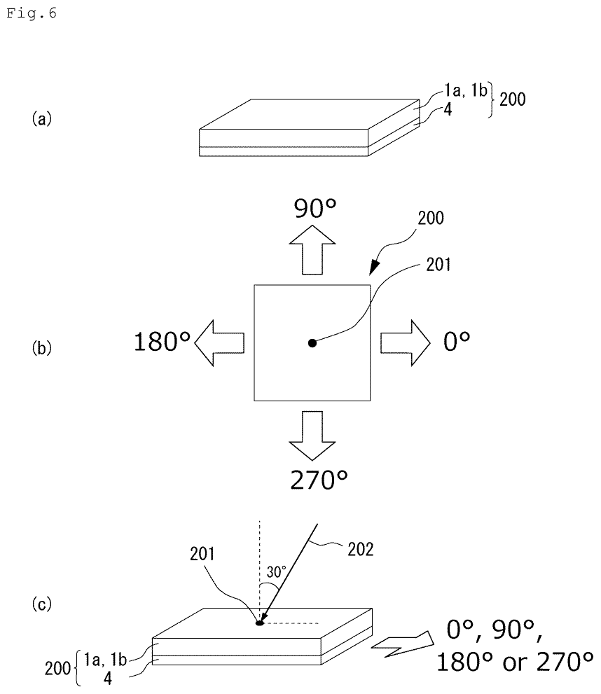

The above tilt will be described in more detail based on FIG. 5. In the perspective view of FIG. 5, although there would normally be a plurality of regions 111 having a relatively high refractive index inside the light diffusion control layer 11, but for descriptive purposes, only one region is left and others are omitted. In FIG. 5, the regions 111 having a relatively high refractive index extend from the bottom to the top, and a straight line parallel to the direction of that extension (direction A) is tilted by an angle “a” with respect to the thickness direction (direction B) of the light diffusion control layer 11.

When the regions (columnar bodies) 111 having a relatively high refractive index are bent as described later, the above-described direction of extension (direction A) refers to the extending direction of the columnar bodies from the bent sites to one end, and in particular, refers to the extending direction from the bent sites to one end on the viewer side.

In the light diffusion control member 1a, 1b according to the present embodiment, the above angle “a” may be preferably greater than 0°, particularly preferably 1° or more, and further preferably 2° or more. By being in such a range, it is possible to display the display content more brightly. From another aspect, the angle “a” may be preferably 30° or less, more preferably 15° or less, particularly preferably 8° or less, and further preferably 5° or less. By being in such a range, it is possible to further reduce the difference in brightness when the up-down direction of the display content is changed. The above angle “a” can be measured by observing the cross section of the light diffusion control layer 11 using an optical digital microscope.

In addition, in the light diffusion control layer 11 in the present embodiment, from the viewpoint that the aforementioned conditions of L₁, L₂, and L₃ can be readily satisfied, the columnar bodies 111 may be bent between one end and another end in at least one layer formed of a column structure. The column structure illustrated in FIG. 4(a) is an example of a column structure including such bent columnar bodies 111. Also in the column structure illustrated in FIG. 4(b), the columnar bodies 111 are bent in the lower layer.

Furthermore, from the viewpoint that the aforementioned conditions of L₁, L₂, and L₃ can be readily satisfied, the light diffusion control layer 11 in the present embodiment may preferably include two layers formed of column structures. That is, as in the column structure illustrated in FIG. 4(b), the columnar bodies 111, which are densely arranged to stand, may be stacked in two layers. In this case, the form of tilt and bending in each layer may be the same or different between the two layers, but preferably, as in the column structure illustrated in FIG. 4(b), the column structure may be preferably composed of two layers: a layer 1 including columnar bodies standing almost parallel to the thickness direction of the light diffusion control layer (i.e., almost perpendicular to the main surface of the light diffusion control layer); and a layer 2 including columnar bodies that are tilted to the thickness direction of the light diffusion control layer and bent at the middle in the extending direction, and it may be particularly preferred that the layer 1 of these layer 1 and layer 2 be arranged on the viewer side.

In the above column structure, the difference between the refractive index of the regions 111 (columnar bodies) having a relatively high refractive index and the refractive index of the region 112 having a relatively low refractive index may be preferably 0.01 or more, particularly preferably 0.05 or more, and further preferably 0.1 or more. This allows effective diffusion to be performed. The upper limit of the above difference is not particularly limited and may be, for example, 0.3 or less. The upper limit of the above difference is not particularly limited, and may be, for example, 0.3 or less. The refractive index when calculating the above difference is the refractive index measured for each of the cured products obtained by curing the material of the regions 111 having a relatively high refractive index and the material of the region 112 having a relatively low refractive index. The material as referred to herein may contain, in addition to the aforementioned high refractive index component and low refractive index component as essential components, other additives such the as aforementioned photopolymerization initiator and ultraviolet absorber as necessary. When other additives are used, the content and specific examples thereof may be as described previously.

Preferably, the above-described columnar bodies may have a structure in which the diameter increases from one surface to the other surface of the light diffusion control layer 11. The columnar bodies having such a structure may readily change the traveling direction of light parallel to the extending direction of the columnar bodies as compared with columnar bodies in which the diameter does not substantially change from one surface to the other surface. This allows the light diffusion control layer 11 to effectively diffuse light.

The maximum value of the diameter in the cross sections when the columnar bodies are cut along a plane horizontal to the extending direction may be preferably 0.1 to 15 μm, particularly preferably 0.5 to 10 μm, and further preferably 1 to 5 μm. When the maximum value of the diameter falls within the above range, the light diffusion control layer 11 can effectively diffuse light. The cross-sectional shape when cut along a plane perpendicular to the extending direction of the columnar bodies is not particularly limited, but may be preferably, for example, a circle, an ellipse, a polygonal shape, an irregular shape, or other similar shape.

In the above-described column structure, the distance between adjacent columnar bodies may be preferably 0.1 to 15 μm, particularly preferably 0.5 to 10 μm, and further preferably 1 to 5 μm. When the distance between adjacent columnar bodies falls within the above range, the light diffusion control layer 11 can effectively diffuse light.

The dimensions relating to the regular internal structure of the column structure described above, etc. can be measured by observing the cross section of the column structure using an optical digital microscope.

### (6) Thickness of Light Diffusion Control Layer

The thickness of the light diffusion control layer 11 may be preferably 1 to 500 μm, more preferably 10 to 300 μm, particularly preferably 30 to 200 μm, further preferably 50 to 150 μm, especially preferably 70 to 130 μm, and most preferably 80 to 115 μm. When the thickness falls within the above range, the aforementioned conditions of L₁, L₂, and L₃ can be readily satisfied. In addition, it is possible to prevent the image blurring and a decrease in the total luminous transmittance.

When the light diffusion control layer 11 has a two-layer stacked structure as illustrated in FIG. 4(b), the total thickness of the two layers may be preferably 1 to 500 μm, more preferably 50 to 400 μm, particularly preferably 100 to 300 μm, and further preferably 150 to 250 μm. In the above two layers, the thickness of the layer disposed on the viewer side may be preferably 1 to 300 μm, more preferably 25 to 200 μm, and particularly preferably 50 to 150 μm. In the above two layers, the thickness of the layer disposed on the opposite side to the viewer may be preferably 1 to 300 μm, more preferably 25 to 200 μm, and particularly preferably 50 to 150 μm. From the viewpoint that the aforementioned conditions of L₁, L₂, and L₃ can be readily satisfied, it may be preferred to satisfy the above thickness range.

### 2. Diffusion Pressure Sensitive Adhesive Layer

The diffusion pressure sensitive adhesive layer 12 in the present embodiment is not particularly limited, provided that it contains light-diffusing fine particles. The pressure sensitive adhesive constituting the diffusion is also not pressure sensitive adhesive layer 12 particularly limited, and examples thereof include acrylic-based pressure sensitive adhesives, polyester-based pressure sensitive adhesives, polyurethane-based pressure sensitive adhesives, rubber-based pressure sensitive adhesives, and silicone-based pressure sensitive adhesives. The pressure sensitive adhesive may be any of emulsion type, solvent type, or non-solvent type and may also be crosslinked type or non-crosslinked type. Among these, acrylic-based pressure sensitive adhesives may be preferred because they are excellent in the pressure sensitive adhesive physical properties, optical characteristics, etc. As the acrylic-based pressure sensitive adhesives, crosslinking type ones may be preferred, thermal crosslinking type ones may be further preferred.

When the diffusion pressure sensitive adhesive layer 12 in the present embodiment is composed of an acrylic-based pressure sensitive adhesive, the pressure sensitive adhesive may be preferably formed by crosslinking a composition for forming diffusion pressure sensitive adhesive layer that contains a (meth)acrylic ester polymer, a crosslinker, and light-diffusing fine particles. As used in the present specification, the term “polymer” encompasses the concept of a “copolymer.”

### (1) Components of Composition for Forming Diffusion

Pressure Sensitive Adhesive Layer

### (1-1) (Meth)Acrylic Ester Polymer

The (meth)acrylic ester polymer in the present embodiment may preferably contain, as a monomer unit that constitutes polymer, a reactive group-containing monomer having in the molecule a reactive group that reacts with the crosslinker. The reactive group derived from the reactive group-containing monomer reacts with the crosslinker to form a crosslinked structure (three-dimensional network structure), and a pressure sensitive adhesive having desired cohesive strength can be obtained.

Preferred examples of the reactive group-containing monomer include a monomer having a hydroxy group in the molecule (hydroxy group-containing monomer), a monomer having a carboxy group in the molecule (carboxy group-containing monomer), and a monomer having an amino group in the molecule (amino group-containing monomer). Among these, the hydroxy group-containing monomer may be preferred because it is excellent in the reactivity with the crosslinker.

Preferred examples of the hydroxy group-containing monomer include hydroxyalkyl (meth)acrylates such as 2-hydroxyethyl (meth)acrylate, 2-hydroxypropyl (meth)acrylate, 3-hydroxypropyl (meth)acrylate, 2-hydroxybutyl (meth)acrylate, 3-hydroxybutyl (meth)acrylate, and 4-hydroxybutyl (meth)acrylate. Among these, hydroxyalkyl (meth)acrylates having a hydroxyalkyl group whose carbon number is 1 to 4 may be preferred from the viewpoints of the reactivity of the hydroxy group in the obtained (meth)acrylic ester polymer with the crosslinker and the copolymerizability with other monomers. Specifically, for example, 2-hydroxyethyl (meth)acrylate, 4-hydroxybutyl (meth)acrylate, or the like may be preferred. These may each be used alone or two or more types may also be used in combination.

The (meth)acrylic ester polymer may preferably contain 1 to 50 mass %, more preferably 7 to 45 mass %, particularly preferably 13 to 40 mass %, further preferably 18 to 35 mass %, and especially preferably 22 to 30 mass % of the reactive group-containing monomer as a monomer unit that constitutes the polymer. This allows a good crosslinked structure to be readily formed in the obtained pressure sensitive adhesive, and the dispersibility of the light-diffusing fine particles in the pressure sensitive adhesive tends to be satisfactory.

The (meth)acrylic ester polymer may also preferably contain (meth)acrylic alkyl ester as a monomer unit that constitutes the polymer. This can develop good pressure sensitive adhesive properties. The alkyl group may be linear or branched.

From the viewpoint of the pressure sensitive adhesive properties, (meth)acrylic alkyl ester whose carbon number of alkyl group is 1 to 20 may be preferred as the (meth)acrylic alkyl ester, and preferred examples thereof include methyl (meth)acrylate, ethyl (meth)acrylate, propyl (meth)acrylate, n-butyl (meth)acrylate, n-pentyl (meth)acrylate, n-hexyl (meth)acrylate, 2-ethylhexyl (meth)acrylate, isooctyl (meth)acrylate, n-decyl (meth)acrylate, n-dodecyl (meth)acrylate, myristyl (meth)acrylate, palmityl (meth)acrylate, and stearyl (meth)acrylate. Among these, from the viewpoint of more improving the pressure sensitive adhesive properties, (meth)acrylic alkyl ester whose carbon number of alkyl group is 4 to 8 may be preferred, and n-butyl (meth)acrylate, 2-ethylhexyl (meth)acrylate, or isooctyl (meth)acrylate may be particularly preferred. These may each be used alone or two or more types may also be used in combination.

The (meth)acrylic ester polymer may preferably contain 20 to 99 mass %, more preferably 30 to 90 mass %, particularly preferably 40 to 80 mass %, and further preferably 45 to 70 mass % of the (meth)acrylic alkyl ester as a monomer unit that constitutes the polymer. This allows the obtained pressure sensitive adhesive to exhibit suitable pressure sensitive adhesive properties. Moreover, the dispersibility of the light-diffusing fine particles in the pressure sensitive adhesive tends to be satisfactory, and the desired light diffusivity can be readily exhibited without impairing the desired pressure sensitive adhesive properties. Furthermore, a suitable amount of other monomer components such as a reactive functional group-containing monomer can be introduced into the (meth)acrylic ester polymer.

The (meth)acrylic ester polymer may also preferably contain a monomer having an alicyclic structure in the molecule (alicyclic structure-containing monomer) as a monomer unit that constitutes the polymer. Since the alicyclic structure-containing monomer is bulky, it is presumed that the presence of such monomers in the polymer widens the distance between the polymer molecules, which tends to reduce the viscosity of the coating liquid and improve the dispersibility of the light-diffusing fine particles in the pressure sensitive adhesive.

The carbon ring of the alicyclic structure in the alicyclic structure-containing monomer may have a saturated structure or may also have an unsaturated bond as a part. The alicyclic structure may be a monocyclic alicyclic structure or may also be a polycyclic alicyclic structure. From the above viewpoints, the alicyclic structure may be preferably a polycyclic alicyclic structure (polycyclic structure) and particularly preferably a polycyclic structure having two to four rings. Also from the above viewpoints, the carbon number of the alicyclic structure (the number of all carbon atoms in a portion that forms the ring, and when two or more rings are independently present, the total carbon number) may be preferably 5 to 15 and particularly preferably 7 to 10.

Specific examples of the alicyclic structure-containing monomer include cyclohexyl (meth)acrylate, dicyclopentanyl (meth)acrylate, adamantyl (meth)acrylate, isobornyl (meth)acrylate, dicyclopentenyl (meth)acrylate, and dicyclopentenyloxyethyl (meth)acrylate. Among these, dicyclopentanyl (meth)acrylate (carbon number of alicyclic structure: 10), adamantyl (meth)acrylate (carbon number of alicyclic structure: 10), or isobornyl (meth)acrylate (carbon number of alicyclic structure: 7) may be preferred from the viewpoint that they exhibit dispersibility of the light-diffusing fine particles in the pressure sensitive adhesive and excellent pressure sensitive adhesive properties. In particular, isobornyl (meth)acrylate may be preferred. These may each be used alone or two or more types may also be used in combination.

When containing an alicyclic structure-containing monomer as a monomer unit that constitutes the polymer, the (meth)acrylic ester polymer may preferably contain 1 to 20 mass %, particularly preferably 5 to 15 mass %, and further preferably 7 to 12 mass % of the alicyclic structure-containing monomer. This can improve the dispersibility of the light-diffusing fine particles in the pressure sensitive adhesive, and the obtained pressure sensitive adhesive can exhibit the desired light diffusivity.

The (meth)acrylic ester polymer may also preferably contain a nitrogen atom-containing monomer as a monomer unit that constitutes the polymer. By allowing a nitrogen atom-containing monomer to exist in the polymer as a constituent unit, the pressure sensitive adhesive is imparted with a predetermined polarity and can have excellent affinity even for an adherend having a certain degree of polarity, such as glass. As the nitrogen atom-containing monomer, from the viewpoint of imparting appropriate rigidity to the (meth)acrylic ester polymer, a monomer having a nitrogen-containing heterocyclic ring may be preferred. Additionally or alternatively, from the viewpoint of increasing the degree of freedom of the portion derived from the above nitrogen atom-containing monomer in a high-dimensional structure of the pressure sensitive adhesive under construction, it is preferred that the nitrogen atom-containing monomer should not contain a reactive unsaturated double bond group other than polymerizable group used during the polymerization for forming the (meth)acrylic ester polymer.

Examples of the monomer having a nitrogen-containing heterocycle include N-(meth)acryloyl morpholine, N-vinyl-2-pyrrolidone, N-(meth)acryloyl pyrrolidone, N-(meth)acryloyl piperidin, N-(meth)acryloyl pyrrolidine, N-(meth)acryloyl aziridine, aziridinyl ethyl (meth)acrylate, 2-vinylpyridine, 4-vinylpyridine, 2-vinylpyrazine, 1-vinylimidazole, N-vinylcarbazole, and N-vinylphthalimide. Among these, N-(meth)acryloylmorpholine may be preferred from the viewpoint of exhibiting dispersibility of the light-diffusing fine particles in the pressure sensitive adhesive and excellent adhesive strength. These may each be used alone or two or more types may also be used in combination.

When containing a nitrogen atom-containing monomer as a monomer unit that constitutes the polymer, the (meth)acrylic ester polymer may preferably contain 1 to 20 mass %, particularly preferably 3 to 16 mass %, and further preferably 5 to 12 mass % of the nitrogen atom-containing monomer. This allows the obtained pressure sensitive adhesive to sufficiently exhibit excellent adhesive strength to glass metal or film. Moreover, the dispersibility of the light-diffusing fine particles in the pressure sensitive adhesive may be satisfactory, and the obtained pressure sensitive adhesive can exhibit the desired light diffusivity.

The (meth)acrylic ester polymer may contain other monomers, if desired, as a monomer unit that constitutes the polymer. As other monomers, monomers containing no reactive functional groups may be preferred so as not to inhibit the aforementioned effects of the reactive functional group-containing monomers. Preferred examples of such monomers include alkoxyalkyl (meth)acrylates such as methoxyethyl (meth)acrylate and ethoxyethyl (meth)acrylate, vinyl acetate, and styrene. These may each be used alone or two or more types may also be used in combination.

The (meth)acrylic ester polymer may be preferably a linear polymer. This can promote the entanglement of molecular chains, and improvement in the cohesive strength can be expected; therefore, a pressure sensitive adhesive excellent in the pressure sensitive adhesive properties and durability can readily be obtained.

The (meth)acrylic ester polymer may be preferably a solution polymerization product obtained by a solution polymerization method. This allows a high molecular-weight polymer to be easily obtained, and improvement in the cohesive strength can be expected; therefore, a pressure sensitive adhesive excellent in the pressure sensitive adhesive properties and durability can readily be obtained.

The polymerization form of the (meth)acrylic ester polymer may be a random copolymer or may also be a block copolymer.

The weight-average molecular weight of the (meth)acrylic ester polymer may be preferably 200,000 to 2,000,000, more preferably 300,000 to 1,500,000, particularly preferably 400,000 to 1,000,000, and further preferably 500,000 to 700,000. This allows the dispersibility of the light-diffusing fine particles in the pressure sensitive adhesive to be satisfactory, and the obtained pressure sensitive adhesive can exhibit the desired light diffusivity and good pressure sensitive adhesive properties.

In the composition for forming diffusion pressure sensitive adhesive layer, one type of the (meth)acrylic ester polymer may be used alone or two or more types may also be used in combination.

### (1-2) Crosslinker

It may be sufficient that the crosslinker is reactive with a reactive group possessed by the (meth)acrylic ester polymer. Examples of the crosslinker include an isocyanate-based crosslinker, an epoxy-based crosslinker, an amine-based crosslinker, a melamine-based crosslinker, an aziridine-based crosslinker, a hydrazine-based crosslinker, an aldehyde-based crosslinker, an oxazoline-based crosslinker, a metal alkoxide-based crosslinker, a metal chelate-based crosslinker, a metal salt-based crosslinker, and an ammonium salt-based crosslinker. It may be preferred to use, among the above, the isocyanate-based crosslinker having excellent reactivity with the hydroxy group. One type of the crosslinker may be used alone or two or more types may also be used in combination.

The isocyanate-based crosslinker contains at least a polyisocyanate compound. Examples of the polyisocyanate compound include aromatic polyisocyanates such as tolylene diisocyanate, diphenylmethane diisocyanate and xylylene diisocyanate, aliphatic polyisocyanates such as hexamethylene diisocyanate, alicyclic polyisocyanates such as isophorone diisocyanate and hydrogenated diphenylmethane diisocyanate, biuret bodies and isocyanurate bodies thereof, and adduct bodies that are reaction products with low molecular active hydrogen-containing compounds such as ethylene glycol, propylene glycol, neopentyl glycol, trimethylol propane, and castor oil. Among these, from the viewpoint of reactivity with hydroxy groups, trimethylolpropane-modified aromatic polyisocyanate may be preferred, and trimethylolpropane-modified tolylene diisocyanate and trimethylolpropane-modified xylylene diisocyanate may be particularly preferred.

The content of the crosslinker in the composition for forming diffusion pressure sensitive adhesive layer may be preferably 0.01 to 10 mass parts, more preferably 0.04 to 5 mass parts, particularly preferably 0.08 to 1 mass part, and further preferably 0.1 to 0.4 mass parts with respect to 100 mass parts of the (meth)acrylic ester polymer. This allows the obtained pressure sensitive adhesive to have suitable cohesive strength, adhesive strength, etc.

### (1-3) Light-Diffusing Fine Particles

Examples of the light-diffusing fine particles include: inorganic fine particles such as silica, calcium carbonate, aluminum hydroxide, magnesium hydroxide, clay, talc, and titanium dioxide; organic transparent fine particles such as acrylic resins, polystyrene resins, polyethylene resins, and epoxy resins; and fine particles composed of a silicon-containing compound having an intermediate structure between inorganic one and organic one, such as silicone resins (e.g., Tospearl series available from Momentive Performance Materials Japan). Among these, fine particles composed of a silicon-containing compound having an intermediate structure between inorganic one and organic one and inorganic fine particles may be preferred, fine particles composed of a silicon-containing an intermediate compound having structure between inorganic one and organic one and titanium dioxide may be particularly preferred from the viewpoint that the aforementioned conditions of L₁, L₂, and L₃ can be readily satisfied, and fine particles composed of a silicon-containing compound having an intermediate structure between inorganic one and organic one may be further preferred from the viewpoint of suppressing the backscattering. One type of the above light-diffusing fine particles may be used alone, or two or more type may also be used in combination.

The shape of the light-diffusing fine particles may be regular or irregular, but from the viewpoints that the light diffusion is uniform and the obtained diffusion pressure sensitive adhesive layer can readily exhibit the desired optical performance, regular fine particles may be preferred, spherical fine particles may be particularly preferred, and true spherical fine particles may be further preferred. This allows the obtained diffusion pressure sensitive adhesive layer to readily exhibit the desired light diffusivity, and the aforementioned conditions of L₁, L₂, and L₃ can be readily satisfied. Moreover, light loss due to backscattering is less likely to occur, and good image quality can thus be provided.

The average particle diameter of the light-diffusing fine particles as determined by a centrifugal sedimentation light transmission method may be preferably 0.1 to 20.0 μm and more preferably 0.2 to 15.0 μm. From the viewpoint of suppressing backscattering, the average particle diameter may be preferably 0.5 to 10.0 μm, particularly preferably 3.0 to 6.0 μm, and further preferably 4.0 to 5.0 μm. This allows the obtained diffusion pressure sensitive adhesive layer to exhibit the desired light diffusivity, and the aforementioned conditions of L₁, L₂, and L₃ can be readily satisfied. In particular, light loss due to backscattering is less likely to occur, and good image quality can thus be provided.

The average particle diameter determined by the above centrifugal sedimentation light transmission method is a value measured using an automated centrifugal particle size distribution analyzer (CAPA-700 available from HORIBA, Ltd.) with a sample for measurement obtained by sufficiently stirring 1.2 g of fine particles and 98.8 g of isopropyl alcohol.

With regard to the average particle diameter of the light-diffusing fine particles, when the light-diffusing fine particles are so-called nanoparticles and it is difficult to measure them by the above centrifugal sedimentation light transmission method, the average particle diameter refers to a diameter measured by the laser diffraction/scattering method. In this case, the average particle diameter of the light-diffusing fine particles measured by the laser diffraction/scattering method may be preferably 10 to 1,000 nm, particularly preferably 100 to 600 nm, and further preferably 200 to 400 nm. This allows the obtained diffusion pressure sensitive adhesive layer to readily exhibit the desired light diffusivity, and the aforementioned conditions of L₁, L₂, and L₃ can be readily satisfied.

The content of the light-diffusing fine particles in the composition for forming diffusion pressure sensitive adhesive layer may be preferably 0.1 to 50 mass parts, more preferably 0.4 to 40 mass parts, particularly preferably 1 to 30 mass parts, further preferably 5 to 22 mass parts, and especially preferably 10 to 16 mass parts with respect to 100 mass parts of the above (meth)acrylic ester polymer. This allows the obtained diffusion pressure sensitive adhesive layer to readily exhibit the desired light diffusivity, and the aforementioned conditions of L₁, L₂, and L₃ can be readily satisfied. Moreover, light loss due to backscattering is less likely to occur, and good image quality can thus be provided. Furthermore, the product can readily exhibit excellent durability while exhibiting the desired light diffusivity.

### (1-4) Other Components

The composition for forming diffusion pressure sensitive adhesive layer may contain components other than the above-described (meth)acrylic ester polymer, crosslinker, and light-diffusing fine particles. For example, the composition may contain an active energy ray curable component from the viewpoint of imparting active energy ray curability to the obtained pressure sensitive adhesive. In this case, it may also be preferred to contain a photopolymerization initiator from the viewpoint of efficiently progressing the curing by active energy rays. In addition, the composition for forming diffusion pressure sensitive adhesive layer can contain one or more of various additives, such as a silane coupling agent, an antirust, an ultraviolet absorber, an infrared absorber, a colorant, an antistatic, a tackifier, an antioxidant, a light stabilizer, a softening agent, and a refractive index adjuster, which are commonly used in acrylic-based pressure sensitive adhesives. The additives which constitute the composition for forming diffusion pressure sensitive adhesive layer are deemed not to include a polymerization solvent or a diluent solvent, which will be described later.

The composition for forming diffusion pressure sensitive adhesive layer may preferably contain a silane coupling agent among the above. This can improve the interfacial adhesion with an adherend even when the adherend is a plastic plate, a glass member, or a metal film, and the durability can be excellent. The silane coupling agent may be preferably an organosilicon compound having at least one alkoxysilyl group in the molecule, which has satisfactory compatibility with the (meth)acrylic ester polymer and light transmittance.

Preferred examples of the silane coupling agent include polymerizable unsaturated group-containing silicon compounds, silicon compounds having an epoxy structure, mercapto group-containing silicon compounds, amino group-containing silicon compounds, and condensates with alkyl group-containing silicon compounds. Among these, silicon compounds having an epoxy structure may be preferred, and 3-glycidoxypropyltrimethoxysilane may be particularly preferred, from the viewpoints that the aforementioned conditions of L₁, L₂, and L₃ can be readily satisfied without impairing the desired light diffusivity and that the durability can be improved. These may each be used alone or two or more types may also be used in combination.

The content of the silane coupling agent in the composition for forming diffusion pressure sensitive adhesive layer may be preferably 0.01 to 2 mass parts, more preferably 0.05 to 1.5 mass parts, particularly preferably 0.1 to 1 mass part, and further preferably 0.2 to 0.5 mass parts with respect to 100 mass parts of the (meth)acrylic ester polymer. This allows the obtained diffusion pressure sensitive adhesive layer readily to satisfy the aforementioned conditions of L₁, L₂, and L₃ without impairing the desired light diffusivity and to improve the durability.

(2) Preparation of Composition for forming Diffusion Pressure Sensitive Adhesive Layer

The composition for forming diffusion pressure sensitive adhesive layer can be prepared through producing the (meth)acrylic ester polymer and mixing the obtained (meth)acrylic ester polymer, the crosslinker, and the light-diffusing fine particles, and, if desired, adding other additives, etc.

The (meth)acrylic ester polymer can be manufactured by polymerizing a mixture of the monomers which constitute the polymer using a commonly-used radical polymerization method. The polymerization may be preferably carried out by a solution polymerization method, if desired, using a polymerization initiator. However, the present invention is not limited to this, and the polymerization may be performed without a solvent. Examples of the polymerization solvent include ethyl acetate, n-butyl acetate, isobutyl acetate, toluene, acetone, hexane, and methyl ethyl ketone. One type of the polymerization solvent may be used alone, or two or more types may also be used in combination. Examples of the polymerization initiator include azo-based compounds and organic peroxides. One type of the polymerization initiator may be used alone, or two or more types may also be used in combination. In the above polymerization step, the weight-average molecular weight of the obtained polymer can be adjusted by compounding a chain transfer agent such as 2-mercaptoethanol.

After the (meth)acrylic ester polymer is obtained, the composition for forming diffusion pressure sensitive adhesive layer (coating solution) diluted with a solvent may be obtained through adding the crosslinker and the light-diffusing fine particles and, if desired, other additives, etc. to the solution of the polymer and sufficiently mixing them. If any of the above components is in the form of a solid, or if precipitation occurs when the component is mixed with another component in an undiluted state, the component may be preliminarily dissolved in or diluted with a dilution solvent alone and then mixed with the other component.

Examples of the dilution solvent for use include aliphatic hydrocarbons such as hexane, heptane and cyclohexane, aromatic hydrocarbons such as toluene and xylene, halogenated hydrocarbons such as methylene chloride and ethylene chloride, alcohols such as methanol, ethanol, propanol, butanol and 1-methoxy-2-propanol, ketones such as acetone, methyl ethyl ketone, 2-pentanone, isophorone and cyclohexanone, esters such as ethyl acetate and butyl acetate, and cellosolve-based solvents such as ethyl cellosolve.

The concentration/viscosity of the coating solution thus prepared is not particularly limited and can be appropriately selected depending on the situation, provided that the concentration/viscosity falls within any range in which the coating is possible. For example, the composition for forming diffusion pressure sensitive adhesive layer may be diluted to a concentration of 10 to 60 mass %. When obtaining the coating solution, the addition of a dilution solvent or the like is not a necessary condition, and the dilution solvent may not be added if the composition for forming diffusion pressure sensitive adhesive layer has a viscosity or the like that enables the coating. In this case, the composition for forming diffusion pressure sensitive adhesive layer may be a coating solution in which the polymerization solvent itself for the (meth)acrylic ester polymer is used as a dilution solvent.

### (3) Thickness of Diffusion Pressure Sensitive Adhesive Layer

The thickness of the diffusion pressure sensitive adhesive layer 12 may be preferably 1 to 500 μm, more preferably 10 to 300 μm, particularly preferably 20 to 100 μm, further preferably 30 to 75 μm, especially preferably 38 to 55 μm, and most preferably 42 to 48 μm. When the thickness falls within the above range, the aforementioned conditions of L₁, L₂, and L₃ can be readily satisfied. Moreover, it is possible to prevent the image blurring and a decrease the in total luminous transmittance. Furthermore, good durability can be exhibited.

The haze value of the diffusion pressure sensitive adhesive layer 12 may be preferably 20% to 100%, more preferably 40% to 96%, particularly preferably 60% to 92%, further preferably 70% to 90%, and especially preferably 80% to 88%. When the haze value falls within the above range, the aforementioned conditions of L₁, L₂, and L₃ can be readily satisfied. Moreover, light loss due to backscattering is less likely to occur, and good image quality can thus be provided. As used in the present specification, the haze value refers to a value measured as in the testing example, which will be described later.

### 3. Intermediate Pressure Sensitive Adhesive Layer

The light diffusion control member 1b illustrated in FIG. 2 includes an intermediate pressure sensitive adhesive layer 13. The intermediate pressure sensitive adhesive layer 13 provides sufficient interfacial adhesion to the light diffusion control layer 11 and the diffusion pressure sensitive adhesive layer 12, and can suppress the occurrence of delamination or displacement of these layers.

As a result, the light diffusion control member 1b including the intermediate pressure sensitive adhesive layer 13 can be excellent in the durability. From the viewpoint of readily achieving the excellent durability, the intermediate pressure sensitive adhesive layer 13 may be preferably composed of a pressure sensitive adhesive containing a carboxy group.

The pressure sensitive adhesive constituting the intermediate pressure sensitive adhesive layer 13 is not particularly limited, and examples thereof include acrylic-based pressure sensitive adhesives, polyester-based pressure sensitive adhesives, polyurethane-based pressure sensitive adhesives, rubber-based pressure sensitive adhesives, and silicone-based pressure sensitive adhesives. The pressure sensitive adhesive may be any of emulsion type, solvent type, or non-solvent type and may also be crosslinked type or non-crosslinked type. Among these, acrylic-based pressure sensitive adhesives may be preferred because they are excellent in the pressure sensitive adhesive physical properties, optical characteristics, etc. As the acrylic-based pressure sensitive adhesives, crosslinking type ones may be preferred, and thermal crosslinking type ones may be further preferred.

When the intermediate pressure sensitive adhesive layer 13 in the present embodiment is composed of an acrylic-based pressure sensitive adhesive, the pressure sensitive adhesive may be preferably formed by crosslinking a composition for forming intermediate pressure sensitive adhesive layer that contains a (meth)acrylic ester polymer and a crosslinker.

The above (meth)acrylic ester polymer may be the same as or different from the (meth)acrylic ester polymer used to form the diffusion pressure sensitive adhesive layer 12. From the of viewpoint readily achieving excellent durability by providing sufficient interfacial adhesion to the light diffusion control layer 11 and the diffusion pressure sensitive adhesive layer 12, the (meth)acrylic ester polymer in the intermediate pressure sensitive adhesive layer 13 may preferably contain a carboxyl group-containing monomer as a monomer unit that constitutes the polymer.

Examples of carboxy group-containing monomers include ethylenically unsaturated carboxylic acids such as acrylic acid, methacrylic acid, crotonic acid, maleic acid, itaconic acid, and citraconic acid. Among these, acrylic acid may be preferred from the viewpoints of the reactivity of the carboxy group in the obtained (meth)acrylic ester polymer with the crosslinker and the copolymerizability with other monomers. These may each be used alone or two or more types may also be used in combination.

The (meth)acrylic ester polymer in the intermediate pressure sensitive adhesive layer 13 may preferably contain 1 to 30 mass %, more preferably 3 to 24 mass %, particularly preferably 6 to 18 mass %, and further preferably 9 to 12 mass % of the carboxy group-containing monomer as a monomer unit that constitutes the polymer. This allows the obtained intermediate pressure sensitive adhesive layer 13 to provide sufficient interfacial adhesion to the light diffusion control layer 11 and the diffusion pressure sensitive adhesive layer 12, and excellent durability can be readily achieved.

The (meth)acrylic ester polymer in the intermediate pressure sensitive adhesive layer 13 may also preferably contain (meth)acrylic alkyl ester as a monomer unit that constitutes the polymer. The alkyl (meth)acrylic ester for use may be the same as the alkyl (meth)acrylic ester used to form the diffusion pressure sensitive adhesive layer 12.

The (meth)acrylic ester polymer in the intermediate pressure sensitive adhesive layer 13 may preferably contain 70 to 99 more mass %, preferably 76 to 97 mass %, particularly preferably 82 to 94 mass %, and further preferably 88 to 91 mass % of the (meth)acrylic alkyl ester as a monomer unit that constitutes the polymer. This allows the obtained intermediate pressure sensitive adhesive layer 13 to develop good pressure sensitive adhesive properties and readily achieve excellent durability.

The weight-average molecular weight of the (meth)acrylic ester polymer used in the intermediate pressure sensitive adhesive layer 13 may be preferably 100,000 to 2,000,000, more preferably 200,000 to 1,200,000, particularly preferably 300,000 to 800,000, and further preferably 350,000 to 500,000. This allows the obtained intermediate pressure sensitive adhesive layer 13 to develop good pressure sensitive adhesive properties and readily achieve excellent durability.

It may be sufficient that the crosslinker in the intermediate pressure sensitive adhesive layer 13 is reactive with a reactive group possessed by the (meth)acrylic ester polymer, as with the crosslinker used to form the diffusion pressure sensitive adhesive layer 12, and similar ones may be exemplified. It may be preferred to use, among the above, an epoxy-based crosslinker having excellent reactivity with the carboxy group. One type of the crosslinker may be used alone or two or more types may also be used in combination.

Examples of the epoxy-based crosslinker include 1,3-bis(N,N-diglycidylaminomethyl)cyclohexane, N,N,N′,N′-tetraglycidyl-m-xylylenediamine, ethylene glycol diglycidyl ether, 1,6-hexanediol diglycidyl ether, trimethylolpropane diglycidyl ether, diglycidylaniline, and diglycidylamine. Among these, 1,3-bis(N,N-diglycidylaminomethyl)cyclohexane may be preferred from the viewpoint of reactivity with carboxy groups.

The content of the crosslinker in the composition for forming intermediate pressure sensitive adhesive layer may be preferably 0.001 to 10 mass parts, more preferably 0.005 to 1 mass part, particularly preferably 0.01 to 0.5 mass parts, and further preferably 0.02 to 0.1 mass parts with respect to 100 mass parts of the (meth)acrylic ester polymer. This allows the obtained intermediate pressure sensitive adhesive layer 13 to develop good cohesive strength and pressure sensitive adhesive properties and readily achieve excellent durability.

The composition for forming intermediate pressure sensitive adhesive layer may contain other components in addition to the above-described (meth)acrylic ester polymer and crosslinker. Examples of the other components include the aforementioned components that can be added to the composition for forming diffusion pressure sensitive adhesive layer. From the viewpoint of readily achieving excellent durability, it is preferred that the composition for forming intermediate pressure sensitive adhesive layer should not contain light-diffusing fine particles.

The composition for forming intermediate pressure sensitive adhesive layer can be prepared in the same manner as the composition for forming diffusion pressure sensitive adhesive layer. The (meth)acrylic ester polymer contained in the composition for forming intermediate pressure sensitive adhesive layer can also be prepared in the same manner as the (meth)acrylic ester polymer contained in the composition for forming diffusion pressure sensitive adhesive layer.

The thickness of the intermediate pressure sensitive adhesive layer 13 may be preferably 1 to 300 μm, more preferably 4 to 100 μm, particularly preferably 8 to 60 μm, further preferably 10 to 30 μm, and especially preferably 12 to 20 μm. When the thickness falls within the above range, the intermediate pressure sensitive adhesive layer 13 can provide sufficient interfacial adhesion to the light diffusion control layer 11 and the diffusion pressure sensitive adhesive layer 12, and excellent durability can be readily achieved. Additionally or alternatively, the thickness of the intermediate pressure sensitive adhesive layer 13 may be preferably thinner than the thickness of the light diffusion control layer 11 or the thickness of the diffusion pressure sensitive adhesive layer 12, and particularly preferably thinner than the thicknesses of both layers. This allows the light diffusion control layer 11 and the diffusion pressure sensitive adhesive layer 12 to exhibit respective optical performances while exhibiting excellent durability, and the aforementioned conditions of L₁, L₂, and L₃ can be readily satisfied accordingly.

### 4. Other Elements

The light diffusion control member 1a, 1b according to the present embodiment may include elements other than the above-described light diffusion control layer 11, diffusion pressure sensitive adhesive layer 12, and intermediate pressure sensitive adhesive layer 13. For example, the light diffusion control member 1a, 1b according to the present embodiment may be provided with a release sheet on the surface on the diffusion pressure sensitive adhesive layer 12 side. The release sheet will protect the surface (pressure sensitive adhesive surface) of the diffusion pressure sensitive adhesive layer 12 located on the opposite side to the light diffusion control layer 11 until the surface is attached to a certain object.

Examples of the release sheet for use include resin films such as a polyethylene film, a polypropylene film, a polybutene film, a polybutadiene film, a polymethylpentene film, a polyvinyl chloride film, a vinyl chloride copolymer film, a polyethylene terephthalate film, a polyethylene naphthalate film, a polybutylene terephthalate film, a polyurethane film, an ethylene vinyl acetate film, an ionomer resin film, an ethylene-(meth)acrylic acid copolymer film, an ethylene-(meth)acrylic ester copolymer film, a polystyrene film, a polycarbonate film, a polyimide film, and a fluorine resin film. Crosslinked films thereof may also be used. Laminate films each obtained by laminating a plurality of such films may also be used.

It may be preferred to perform release treatment for the release surface of the release sheet. Preferred examples of a release agent to be used for the release treatment include alkyd-based, silicone-based, fluorine-based, unsaturated polyester-based, polyolefin-based, and wax-based release agents.

The thickness of the release sheet is not particularly limited, but from the viewpoint of excellent handling properties, it may be preferably 20 to 200 μm and more preferably 30 to 100 μm.

Additionally or alternatively, for example, the light diffusion control member 1a, 1b according to the present embodiment may be provided with a process sheet on the surface on the light diffusion control layer 11 side. The process sheet may be used to form the light diffusion control layer 11 by applying the composition for light diffusion control layer, and will protect the surface of the light diffusion control layer 11 located on the opposite side to the diffusion pressure sensitive adhesive layer 12 until the process sheet is removed.

The resin film, crosslinked film, or laminated film thereof used as the above-described release sheet can be used as the process sheet. In the present embodiment, the above release sheet can also be used as the process sheet, which may be preferred in that the desired light diffusion control layer 11 can be readily formed.

The thickness of the process sheet may be preferably 20 to 250 μm and more preferably 30 to 200 μm from the viewpoints that the desired light diffusion control layer 11 can be readily formed and that the light diffusion control layer 11 can be well protected until its use.

The light diffusion control member 1a, 1b according to the present embodiment may also have a configuration in which an intermediate pressure sensitive adhesive layer is provided on the surface of the light diffusion control layer 11 opposite to the diffusion pressure sensitive adhesive layer 12. That is, the light diffusion control member 1a, 1b according to the present embodiment may have a layer configuration of intermediate pressure sensitive adhesive layer/light diffusion control layer 11/diffusion pressure sensitive adhesive layer 12, or may have a layer configuration of intermediate pressure sensitive adhesive layer/light diffusion control layer 11/intermediate pressure sensitive adhesive layer 13/diffusion pressure sensitive adhesive layer 12.

The light diffusion control member 1a, 1b having the above layer configuration may be suitable for manufacturing the reflective display body 100 configured such that its surface on the light diffusion control layer 11 side is laminated to the display device 2 and the reflective layer 3. In the reflective display body 100, the surface of the light diffusion control member 1a, 1b on the light diffusion control layer 11 side can be sufficiently fixed to the display device 2 or the reflective layer 3 via an intermediate pressure sensitive adhesive layer.

The intermediate pressure sensitive adhesive layer provided on the surface of the light diffusion control layer 11 opposite to the diffusion pressure sensitive adhesive layer 12 may be the same as the intermediate pressure sensitive adhesive layer 13 provided between the light diffusion control layer 11 and the diffusion pressure sensitive adhesive layer 12.

### 5. Method of Manufacturing Light Diffusion Control Member

The method of manufacturing the light diffusion control member 1a, 1b according to the present embodiment is not particularly limited, and it can be manufactured by a conventional manufacturing method. For example, the light diffusion control layer 11 and the diffusion pressure sensitive adhesive layer 12 and, if necessary, the intermediate pressure sensitive adhesive layer 13 may each be prepared, and then the light diffusion control layer 11, the diffusion pressure sensitive adhesive layer 12, and the intermediate pressure sensitive adhesive layer 13 may be laminated as appropriate to obtain the light diffusion control member 1a, 1b.

The method of forming the light diffusion control layer 11 is not particularly limited, and it can be formed by a conventionally known method.

For example, one surface of a process sheet may be coated with the aforementioned composition for light diffusion control layer to form a coating film, and one surface of a release sheet (in particular, the release surface) is then attached to the surface of the coating film opposite to the process sheet. Subsequently, the above coating film is irradiated with active energy rays via the process sheet or the release sheet to cure the coating film, and the light diffusion control layer 11 can thereby be formed. Thus, by laminating the release sheet on the above coating film, the light diffusion control layer 11 having a uniform thickness and a regular internal structure can readily be formed while maintaining the gap between the release sheet and the process sheet and suppressing the crushing of the coating film.

Alternatively, for example, after one surface of a process sheet is coated with the aforementioned composition for forming light diffusion control layer to form a coating film, the coating film may be irradiated with active energy rays for a first time to perform primary curing, and then one surface of a release sheet may be attached to the surface of the coating film opposite to the process sheet. The coating film may then be irradiated with active energy rays for a second time through the process sheet or release sheet to perform secondary curing, thereby forming the light diffusion control layer 11. Thus, by performing irradiation with the active energy rays for curing in two stages, it becomes easy to form a two-layer laminated light diffusion control layer 11 as illustrated in FIG. 4(b).

Examples of the method for the above-described coating include a knife coating method, a roll coating method, a bar coating method, a blade coating method, a die coating method, and a gravure coating method. The composition for light diffusion control layer may be diluted using a solvent as necessary.

Irradiation with active energy rays for the coating film may be performed in different ways depending on the regular internal structure to be formed. Such irradiation can be carried out by a conventional method. For example, when forming the aforementioned column structure, the coating film may be irradiated with parallel light with high parallelism.

The above active energy rays refer to electromagnetic wave or charged particle radiation having an energy quantum, and specific examples of the active energy rays include ultraviolet rays and electron rays. Among the active energy rays, ultraviolet rays may be particularly preferred because of easy management and easy formation of a desired regular internal structure.

When forming the column structure using ultraviolet rays as the active energy rays, it may be preferred to set the irradiation condition such that the peak illuminance on the coating film surface is 0.1 to 10 mW/cm². The peak illuminance as referred to herein means a measured value at a portion at which the active energy rays irradiating the coating film surface give the maximum value. Additionally or alternatively, it may be preferred to set the integrated light amount on the coating film surface to 5 to 200 mJ/cm².

From the viewpoint of completing more reliable curing, it may also be preferred to perform the irradiation with commonly-used active energy rays (active energy rays for which the process of converting the rays into parallel light or strip-shaped light is not performed, scattered light) after performing the curing using the parallel light or strip-shaped light as previously described.

The methods of forming the diffusion pressure sensitive adhesive layer 12 and intermediate pressure sensitive adhesive layer 13 are also not particularly limited, and they can be formed by conventionally known methods. For example, they can be formed by crosslinking the aforementioned composition for forming diffusion pressure sensitive adhesive layer and composition for forming intermediate pressure sensitive adhesive layer (or their coating layers). Crosslinking of these compositions can usually be performed by a heat treatment. Drying treatment when volatilizing a diluent solvent and the like from the coating layer of the composition applied to a desired object can also serve as the above heat treatment.

The heating temperature of the heat treatment may be preferably 50° C. to 150° C. and particularly preferably 70° C. to 120° C. The heating time may be preferably 10 seconds to 10 minutes and particularly preferably 50 seconds to 2 minutes.

After the heat treatment, if necessary, an aging period at an ordinary temperature (e.g., 23° C., 50% RH) for about 1 to 2 weeks may be provided. When the aging period is necessary, the diffusion pressure sensitive adhesive layer 12 or the intermediate pressure sensitive adhesive layer 13 may be formed after the aging period passes, while when the aging period is not necessary, the diffusion pressure sensitive adhesive layer 12 or the intermediate pressure sensitive adhesive layer 13 may be formed after the heat treatment is completed.

### 6. Reflective Display Body

As described previously, the light diffusion control member 1a, 1b according to the present embodiment can be suitably used for manufacturing the reflective display body 100. The reflective display body 100 may preferably include, for example, the above-described light diffusion control member 1a, 1b, the display device 2 provided on any one surface side of the light diffusion control member 1a, 1b, and the reflective layer 3 that is provided on the surface side of the display device 2 opposite to the light diffusion control member 1a, 1b or that is incorporated in the display device 2.

The reflective display body 100 can achieve excellent visibility as described previously by including the light diffusion control member 1a, 1b according to the present embodiment. In particular, even when the up-down direction of the display content is changed, a display with uniform brightness can be achieved. Accordingly, the reflective display body 100 may be preferably configured such that the up-down direction of the display content on the display surface can be changed.

The shape of the display surface of the reflective display body 100 is not particularly limited, but typically, the display surface may preferably have a rectangular shape. In this case, the display surface may be a rectangle composed of a pair of long sides and a pair of short sides or may also be a square whose all sides have the same length. When the display surface has such a rectangular shape, the display surface may be preferably configured such that the up-down direction of the display content can take at least a direction parallel to one side of the above rectangle and a direction perpendicular to that direction. Additionally or alternatively, the shape of the display surface may be a quadrangular shape other than a rectangular shape, such as a diamond shape, a trapezoidal shape, or a parallelogram, a circular shape such as a perfect circle or an ellipse, or an irregular shape other than these.

### (1) Display Device

The display device 2 is not particularly limited and may be a display device incorporated in a general reflective display body. Examples of the display device 2 include liquid crystal displays, organic EL displays, electronic paper, electrophoresis displays, MEMS displays, and solid crystal displays, and the display device 13 may also be obtained by laminating a touch panel on any of these displays.

### (2) Reflective Layer

The reflective layer 3 is not particularly limited and may be any of reflective layers used for general reflective display bodies. Preferred examples of the reflective layer 3 include a metal vapor-deposited film obtained by vapor-depositing a metal on a given surface. Preferred examples of such a metal include aluminum, silver, and nickel.

The thickness of the reflective layer 3 made of the metal vapor-deposited film is not particularly limited, but may be preferably, for example, 1 to 3,000 nm, particularly preferably 10 to 1,000 nm, and further preferably 50 to 400 nm from the viewpoint of exerting the desired reflective characteristics.

The reflective layer 3 made of the metal vapor-deposited film may be provided on the surface of a resin film as a support body. Examples of such resin films for use include those exemplified as the above-described release sheets.

The reflective layer 3 may be a reflective electrode. In this case, the reflective electrode may be incorporated, for example, inside the display device 2. In general, the reflective electrode is not provided to cover the entire display surface of the reflective display body 100, and there is a portion on which the electrode is not formed. In the reflective display body 100 including a reflective electrode, therefore, external light can be reflected by the reflective electrode, while on the other hand, light from a backlight or the like provided on the back surface of the display device 2 can be transmitted through the portion on which the electrode is not formed. The material of the reflective electrode as the reflective layer 3 is not particularly limited and can be formed of a general material for reflective electrodes.

In the reflective display body 100 illustrated in FIG. 3, the reflective layer 3 is drawn as a component independent of the display device 2. The reflective layer 3 is also drawn so as to exist in the entire area in the lateral direction (the entire area of the surface of the display device 2 opposite to the light diffusion control member 1). However, the reflective display body 100 according to the present embodiment is not limited to the display body illustrated in FIG. 3 and encompasses a display body that includes the above-described reflective electrode as the reflective layer 3.

The reflective layer 3 may also be a reflective layer having semi-transmissive and semi-reflective properties that exhibits both a property of transmitting light and a property of reflecting light.

### (3) Other Constitutional Members

The reflective display body 100 may include one or more constitutional members other than the above-described light diffusion control member 1a, 1b, display device 2, and reflective layer 3. A surface coat layer, a cover panel, or the like may be provided on the surface side of the light diffusion control member 1a, 1b opposite to the display device 2. Additionally or alternatively, a backlight may be provided on the surface side of the display device 2 opposite to the light diffusion control member 1a, 1b.

### (4) Method of Manufacturing Reflective Display Body

The method of manufacturing the reflective display body 100 is not particularly limited, and it can be manufactured using a conventional manufacturing method. For example, when manufacturing the reflective display body 100 illustrated in FIG. 3, it can be obtained through manufacturing the light diffusion control member 1a, 1b, the display device 2, and the reflective layer 3 and then laminating them.

It should be appreciated that the aforementioned embodiments are described to facilitate understanding of the present invention and are not described to limit the present invention. It is therefore intended that the elements disclosed in the above embodiments include all design changes and equivalents to fall within the technical scope of the present invention.

For example, one or more other layers may be provided between the light diffusion control layer and the diffusion pressure sensitive adhesive layer, or on the surface of the light diffusion control layer opposite to the diffusion pressure sensitive adhesive layer.

In the present specification, unless otherwise specified, the statement of “X to Y” (X and Y are arbitrary numbers) encompasses not only the meaning of “X or more and Y or less” but also the meaning of “preferably more than X” or “preferably less than Y.” In addition, unless otherwise specified, the statement of “X or more” (X is an arbitrary number) encompasses the meaning of “preferably more than X,” and the statement of “Y or less” (Y is an arbitrary number) encompasses the meaning of “preferably less than Y.”

### EXAMPLES

Hereinafter, the present invention will be described further specifically with reference to examples, etc., but the scope of the present invention is not limited to these examples, etc.

### <Preparation Example 1> (Light Diffusion Control Layer A)

### (1) Preparation of Composition for Light Diffusion Control Layer

Polyether urethane methacrylate having a weight-average molecular weight of 9,900 was obtained as the low refractive index component by reacting polypropylene glycol, isophorone diisocyanate, and 2-hydroxyethyl methacrylate.

A composition for light control layer was obtained through adding 60 mass parts (solid content equivalent value, here and hereinafter) of o-phenylphenoxyethoxyethyl acrylate having a molecular weight of 268 as the high refractive index component, 8 mass parts of 2-hydroxy-2-methyl-1-phenylpropan-1-one as the photopolymerization initiator, and 0.08 mass parts of a benzotriazole-based ultraviolet absorber as the ultraviolet absorber (available from BASF, product name “Tinuvin 384-2”) to 40 mass parts of the above low refractive index component and then heating and mixing them under a condition of 80° C.

### (2) Formation of Light Diffusion Control Layer

The release-treated surface of a release sheet as a process sheet (available from LINTEC Corporation, product name “SP-PET188CL,” thickness: 188 μm) obtained by release-treating one surface of a long polyethylene terephthalate sheet with a silicone-based release agent was coated with the obtained composition for light diffusion control layer to form a coating film having a thickness of 110 μm. Subsequently, the release-treated surface of a release sheet (available from LINTEC Corporation, product name “SP-PLZ383030,” thickness: 38 μm) obtained by release-treating one surface of a polyethylene terephthalate film with a silicone-based release agent was laminated on the surface of the coating film opposite to the process sheet.

The resulting laminate consisting of the release sheet, the above coating film, and the process sheet was placed on a conveyor. At that time, the surface of the laminate on the release sheet side was set on the upper side, and the longitudinal direction of the laminate was set parallel to the flow direction of the conveyor. Then, a parallel UV spot light source (available from JATEC) with a controlled central light ray parallelism within ±3° was installed for the conveyor on which the laminate was placed. At that time, the light source was installed such that it was able to irradiate the laminate with parallel light in a direction inclined by 5° to the conveyor flow direction with respect to the normal direction of the surface of the laminate on the coating film side.

After that, while operating the conveyor to move the laminate, the laminate was irradiated with parallel light having a parallelism of 2° or less (ultraviolet rays from a high-pressure mercury lamp with a main peak at a wavelength of 365 nm and other peaks at 254 nm, 303 nm, and 313 nm) under conditions of a peak illuminance of 1.02 mW/cm² on the coating film surface and an integrated light amount of 26.35 mJ/cm² thereby to cure the coating film in the laminate and form a light diffusion control layer A having a thickness of 110 μm. As a result, a laminate was obtained in which the process sheet, the light diffusion control layer A (thickness: 110 μm), and the release sheet were laminated in this order.

The above-described peak illuminance and integrated light amount were measured using a UV METER (available from EYE GRAPHICS CO., LTD., product name “EYE Ultraviolet Integrated Illuminance Meter UVPF-A1”) equipped with a light receiver and installed for the position of the above coating film. The thickness of the light diffusion control layer A was measured using a constant-pressure thickness meter (available from TAKARA SEISAKUSYO, product name “Teclock PG-02J”).

### <Preparation Example 2> (Light Diffusion Control Layer B)

In the same manner as in Preparation Example 1 except that a light diffusion control layer B was formed to have a thickness of 60 μm, a laminate was prepared in which the process sheet, the light diffusion control layer B (thickness: 60 μm), and the release sheet were laminated in this order.

### <Preparation Example 3> (Light Diffusion Control Layer C)

In the same manner as in Preparation Example 1 except that the irradiation angle of the parallel light emitted from the parallel UV spot light source was 10°, a laminate was prepared in which the process sheet, a light diffusion control layer C (thickness: 110 μm), and the release sheet were laminated in this order.

### <Preparation Example 4> (Light Diffusion Control Layer D)

A composition for light diffusion control layer was obtained in the same manner as in step (1) of Preparation Example 1. Then, the release-treated surface of a release sheet as a process sheet (available from LINTEC Corporation, product name “SP-PET188CL,” thickness: 188 μm) obtained by release-treating one surface of a long polyethylene terephthalate film with a silicone-based release agent was coated with the obtained composition for light diffusion control layer to form a coating film having a thickness of 200 μm. The resulting laminate consisting of the above coating film and the process sheet was placed on a conveyor. At that time, the surface of the laminate on the coating film side was set on the upper side, and the longitudinal direction of the laminate was set parallel to the flow direction of the conveyor.

Then, a parallel UV spot light source (available from JATEC) with a controlled central light ray parallelism within ±3° was installed for the conveyor on which the laminate was placed. At that time, the light source was installed such that it was able to irradiate the laminate with parallel light in a direction inclined by 10° to the conveyor flow direction with respect to the normal direction of the surface of the laminate on the coating film side.

After that, while operating the conveyor to move the laminate, the laminate was irradiated with parallel light having a parallelism of 2° or less (ultraviolet rays from a high-pressure mercury lamp with a main peak at a wavelength of 365 nm and other peaks at 254 nm, 303 nm, and 313 nm) under conditions of a peak illuminance of 1.06 mW/cm² on the coating film surface and an integrated light amount of 28.76 mJ/cm² (first stage irradiation).

Subsequently, the release-treated surface of a 38 μm-thick release film with UV transparency (available from LINTEC Corporation, product name “SP-PET382030”) was laminated on the exposed surface of the coating layer.

Then, a parallel UV spot light source (available from JATEC) with a controlled central light ray parallelism within ±3° was installed for the conveyor on which the laminate was placed. At that time, the light source was installed such that it was able to irradiate the laminate with parallel light in a direction inclined by 0° to the conveyor flow direction with respect to the normal direction of the surface of the laminate on the coating film side.

Then, while operating the conveyor to move the laminate, the laminate was irradiated with parallel light having a parallelism of 2° or less (ultraviolet rays from a high-pressure mercury lamp with a main peak at a wavelength of 365 nm and other peaks at 254 nm, 303 nm, and 313 nm) through the release film under conditions of a peak illuminance of 2.54 mW/cm² on the coating film surface and an integrated light amount of 46.76 mJ/cm² (second stage irradiation).

This resulted in the formation of a light diffusion control layer D having a thickness of 200 μm. As a result, a laminate was obtained in which the process sheet, the light diffusion control layer D (thickness: 200 μm), and the release sheet were laminated in this order.

### <Preparation Example 5> (Light Diffusion Control Layer E)

In the same manner as in Preparation Example 1 except that the irradiation angle of the parallel light emitted from the parallel UV spot light source was 20°, a laminate was prepared in which the process sheet, a light diffusion control layer E (thickness: 110 μm), and the release sheet were laminated in this order.

### <Preparation Example 6> (Light Diffusion Control Layer F)

In the same manner as in Preparation Example 1 except that a composition for light diffusion control layer containing no ultraviolet absorber was used, the irradiation angle of the parallel light emitted from the parallel UV spot light source was 15°, and the light diffusion control layer was formed to have a thickness of 120 μm, a laminate was obtained in which the process sheet, a light diffusion control layer F (thickness: 120 μm), and the release sheet were laminated in this order.

Details of the light diffusion control layers A to F prepared as described above are listed in Table 1.

As listed in Table 1, when the cross sections of the formed light diffusion control layers A, B, C, E, and F were observed with a microscope, it was confirmed that a column structure in which a plurality of columnar bodies were densely arranged to stand in the entire thickness direction was formed inside each of the light diffusion control layers A, B, C, E, and F. In other words, the ratio of the column structure region extending in the thickness direction inside each of the obtained light diffusion control layers A, B, C, E, and F was 100%. In addition, when the direction C in FIG. 5 was confirmed in the light diffusion control layers A, B, C, E, and F, it was found that when the ultraviolet ray irradiated surface was on the upper side, the conveyor traveling side (MD direction) and the direction C all coincided.

It was confirmed that the columnar bodies inside the light diffusion control layers A, B, C, and E were all bent at the middle in the extending direction, as illustrated in FIG. 4(a). The angle (angle “a” in FIG. 5) between the extending direction (direction A in FIG. 5) in the portions of the columnar bodies closer to the ultraviolet ray irradiated surface side than the bending sites and the thickness direction of the light diffusion control layer (direction B in FIG. 5) was confirmed to be 3.2° for the light diffusion control layers A and B, 6.4° for the light diffusion control layer C, and 12.7° for the light diffusion control layer E. In the present specification, the angle is expressed as a plus when the A direction is inclined toward the conveyor traveling side (MD direction) with respect to the B direction, and as a minus when the A direction is inclined toward the opposite side to the conveyor traveling side.

It was confirmed that the columnar bodies inside the light diffusion control layer F were not bent and extended in an almost straight line, as illustrated in FIG. 4(c). The angle (angle “a” in FIG. 5) between the extending direction of the columnar bodies (direction A in FIG. 5) and the thickness direction of the light diffusion control layer F (direction B in FIG. 5) was confirmed to be 9.6°. The light diffusion control layer D will be described later.

When the cross section of the light diffusion control layer D was observed with a microscope, it was confirmed that column structures in each of which a plurality of columnar bodies were densely arranged to stand in the entire thickness direction were formed inside the light diffusion control layer D in a two-layered state. When the two layers are considered together as a single layer, the ratio of the column structure region extending in the thickness direction inside the light diffusion control layer D was 100%. The structure of these two layers was the same as that illustrated in FIG. 4(b). That is, in the layer on the ultraviolet ray irradiation side (which may be referred to as a “first layer”), the columnar bodies were confirmed to be densely arranged to stand almost parallel to the thickness direction of the light diffusion control layer D (i.e., almost perpendicular to the main surface of the light diffusion control layer D). On the other hand, in the other layer (which may be referred to as a “second layer”), the columnar bodies were confirmed to be inclined with respect to the thickness direction of the light diffusion control layer D and were bent at the middle in the extending direction. When the direction C of FIG. 5 in the second layer was confirmed, it was found that when the ultraviolet ray irradiated surface was on the upper side, the conveyor traveling side (MD direction) and the direction C coincided. It was also confirmed that the angle (angle “a” in FIG. 5) between the extending direction (direction A in FIG. 5) in the portions of the columnar bodies closer to the ultraviolet ray irradiated surface side than the bending sites and the thickness direction of the light diffusion control layer D (direction B in FIG. 5) was 6.4°.

### <Preparation Example 1> (Composition for forming Intermediate Pressure Sensitive Adhesive Layer)

The (meth)acrylic ester polymer was obtained by using a solution polymerization method to copolymerize 90 mass parts of n-butyl acrylate and 10 mass parts of acrylic acid. The weight-average molecular weight (MW) of the (meth)acrylic ester polymer was measured by the method described later, and it was found to be 400,000.

The coating solution of the composition for forming intermediate pressure sensitive adhesive layer was obtained through mixing and sufficiently stirring 100 mass parts (solid content equivalent, here and hereinafter) of the obtained (meth)acrylic ester polymer and 0.025 mass parts of 1,3-bis(N,N-diglycidylaminomethyl)cyclohexane as a crosslinker and diluting the mixture with methyl ethyl ketone.

### <Preparation Example 2> (Composition for Forming Diffusion Pressure Sensitive Adhesive Layer A)

The (meth)acrylic ester polymer was obtained by using a solution polymerization method to copolymerize 25 mass parts of n-butyl acrylate, 25 mass parts of 2-ethylhexyl acrylate, 10 mass parts of isobornyl acrylate, 10 mass parts of N-acryloylmorpholine, and 30 mass parts of 2-hydroxyethyl acrylate. The weight-average molecular weight (MW) of the (meth)acrylic ester polymer was measured by the method described later, and it was found to be 500,000.

The coating solution of a composition for forming diffusion pressure sensitive adhesive layer A was obtained through mixing and sufficiently stirring 100 mass parts of the obtained (meth)acrylic ester polymer, 0.2 mass parts of an isocyanate-based crosslinker as a crosslinker (available from Mitsui Chemicals, Inc., product name “TAKENATE D-101E”), 15 mass parts of fine particles as the light-diffusing fine particles (“Tospearl 145” available from Momentive Performance Materials Japan, average particle diameter: 4.5 μm) composed of a silicone resin (silicon-containing compound having an intermediate structure between inorganic one and organic one), and 0.3 mass parts of 3-glycidoxypropyltrimethoxysilane as the silane coupling agent and diluting the mixture with methyl ethyl ketone.

### <Preparation Example 3> (Composition for Forming Diffusion Pressure Sensitive Adhesive Layer B)

The coating solution of a composition for forming diffusion pressure sensitive adhesive layer B was obtained in the same manner as in Preparation Example 2 except that 0.5 mass parts of titanium dioxide fine particles (available from Sakai Chemical Industry Co., Ltd., product name “R-62N,” average particle diameter: 260 nm) were used as the light-diffusing fine particles.

The aforementioned weight-average molecular weight (Mw) refers to a weight-average molecular weight that is measured as a polystyrene equivalent value under the following condition using gel permeation chromatography (GPC) (GPC measurement).

### «Measurement Condition»

GPC measurement device: HLC-8020 available from Tosoh Corporation
GPC columns (passing through in the following order): available from Tosoh Corporation
   TSK guard column HXL-H
   TSK gel GMHXL (×2)
   TSK gel G2000HXL
Solvent for measurement: tetrahydrofuran
Measurement temperature: 40° C.

### Example 1

### (1) Formation of Intermediate Pressure Sensitive Adhesive Layer

The release-treated surface of a tight release sheet 1 (available from LINTEC Corporation, product name “SP-PET382050,” thickness: 38 μm) in which one surface of a polyethylene terephthalate film was release-treated with a silicone-based release agent was coated with the coating solution of the composition for forming intermediate pressure sensitive adhesive layer obtained in Preparation Example 1 using a knife coater, and the coating solution was then dried by heating at 90° C. for 1 minute in a drying oven to obtain a coating layer having a thickness of 15 μm.

Subsequently, the release-treated surface of an easy release sheet 1 (available from LINTEC Corporation, product name “SP-PET382120,” thickness: 38 μm) in which one surface of a polyethylene terephthalate film was release-treated with a silicone-based release agent was attached to the surface of the above coating layer opposite to the tight release sheet. After that, the above coating layer was aged for 7 days under conditions of 23° C. and 50% Rh to form an intermediate pressure sensitive adhesive layer.

As a result of the above, a laminate was obtained in which the tight release sheet 1, a 15 μm-thick intermediate pressure sensitive adhesive layer, and the easy release sheet 1 were laminated in this order.

### (2) Formation of Diffusion Pressure Sensitive Adhesive Layer

The release-treated surface of an easy release sheet 2 (available from LINTEC Corporation, product name “SP-PET381031,” thickness: 38 μm) in which one surface of a polyethylene terephthalate film was release-treated with a silicone-based release agent was coated with the coating solution of the composition for forming diffusion pressure sensitive adhesive layer A obtained in Preparation Example 2 using a knife coater, and then heat-treated at 90° C. for 1 minute to form a coating layer (thickness: 40 μm). Subsequently, the release-treated surface of a tight release sheet 2 (available from LINTEC Corporation, product name “SP-PET382120,” thickness: 38 μm) was attached to the surface of the above coating layer opposite to the easy release sheet. After that, the above coating layer was aged for 7 days under conditions of 23° C. and 50% Rh to form a diffusion pressure sensitive adhesive layer.

As a result of the above, a laminate was obtained in which the easy release sheet 2, a 40 μm-thick diffusion pressure sensitive adhesive layer, and the tight release sheet 2 were laminated in this order.

The haze value (%) of the 40 μm-thick diffusion pressure sensitive adhesive layer formed as described above was measured using a haze meter (available from NIPPON DENSHOKU INDUSTRIES CO., LTD., product name “NDH-5000”) in accordance with JIS K7136: 2000, JIS K7361-1:1997, and ASTM D 1003, and it was found to be 74%.

### (3) Preparation of Light Diffusion Control Member

The process sheet was removed from the laminate prepared in Preparation Example 1 to expose the light diffusion control layer A. In addition, the easy release sheet 1 was removed from the laminate prepared in the above step (1) to expose the intermediate pressure sensitive adhesive layer. Then, the exposed surface of the light diffusion control layer A and the exposed surface of the intermediate pressure sensitive adhesive layer were attached to each other. The surface of the light diffusion control layer A opposite to the intermediate pressure sensitive adhesive layer was the surface irradiated with ultraviolet rays when the light diffusion control layer A was formed.

Furthermore, the tight release sheet 1 on the surface of the intermediate pressure sensitive adhesive layer opposite to the light diffusion control layer A was removed, and the surface of the diffusion pressure sensitive adhesive layer exposed by removing the easy release sheet 2 from the laminate prepared in the above step (2) was attached to the exposed surface of the intermediate pressure sensitive adhesive layer. Thus, a light diffusion control member was obtained in which the release sheet, the light diffusion control layer A, the intermediate pressure sensitive adhesive layer, the diffusion pressure sensitive adhesive layer, and the tight release sheet 2 were laminated in this order.

### (4) Preparation of Reflective Display Body Sample

Subsequently, a mirror (available from JDSU, product name “BV2 mirror,” length 75 mm×breadth 65 mm) was prepared. Then, the tight release sheet 2 was removed from the light diffusion control member obtained in the above step (3), and the exposed surface of the diffusion pressure-sensitive adhesive layer was laminated on the reflective surface of the above mirror. Finally, the release sheet laminated on the light diffusion control layer A was removed, thereby obtaining a reflective display body sample.

### Examples 2, 4, and 6 to 8 and Comparative Examples 3 to 5

Light diffusion control members were manufactured in the same manner as in Example 1, except that the types of light diffusion control layer and the thicknesses of diffusion pressure sensitive adhesive layers were as listed in Table 3, and reflective display body samples were also obtained.

### Example 3

A light diffusion control member was manufactured in the same manner as in Example 1, except that the light diffusion control layer and the diffusion pressure sensitive adhesive layer were directly laminated without using an intermediate pressure sensitive adhesive layer, and a reflective display body sample was also obtained.

### Example 5

A light diffusion control member was manufactured in the same manner as in Example 1, except that the coating solution of the composition for forming diffusion pressure sensitive adhesive layer B obtained in Preparation Example 3 was used in forming the diffusion pressure sensitive adhesive layer and the thickness of the diffusion pressure sensitive adhesive layer was 25 μm, and then a reflective display body sample was also obtained. Table 3 lists the haze value (%) of the diffusion pressure sensitive adhesive layer used in this example.

### Example 9

The release sheet was removed from the laminate prepared in Preparation Example 1 to expose the light diffusion control layer A. The easy release sheet 1 was removed from the laminate prepared in the same manner as in step (1) of Example 1, and the exposed surface of the intermediate pressure sensitive adhesive layer and the exposed surface of the light diffusion control layer A were attached to each other. Subsequently, the tight release sheet 1 on the surface of the intermediate pressure sensitive adhesive layer opposite to the light diffusion control layer A was removed, and the exposed surface of the diffusion pressure sensitive adhesive layer exposed by removing the easy release sheet 2 from the laminate prepared in the same manner as in step (2) of Example 1 was attached to the exposed surface of the intermediate pressure sensitive adhesive layer. Furthermore, the process sheet for the light diffusion control layer A was removed, the easy release sheet 1 was removed from the laminate prepared in the same manner as in step (1) of Example 1, and the exposed surface of the intermediate pressure sensitive adhesive layer and the exposed surface of the light diffusion control layer A were attached to each other. Thus, a light diffusion control member was obtained in which the tight release sheet 2, the diffusion pressure sensitive adhesive layer, the intermediate pressure sensitive adhesive layer, the light diffusion control layer A, the intermediate pressure sensitive adhesive layer, and the tight release sheet 1 were laminated in this order. Furthermore, the tight release sheet 1 was removed from the obtained light diffusion control member, and the exposed surface of the intermediate pressure sensitive adhesive layer was laminated on the reflective surface of the mirror in the same manner as in Example 1. Finally, the tight release sheet 2 laminated on the diffusion pressure sensitive adhesive layer was removed to obtain a reflective display body sample.

### Comparative Example 1

A light diffusion control member was manufactured in the same manner as in Example 1, except that the light diffusion control member was provided as a single layer of the diffusion pressure sensitive adhesive layer formed to a thickness of 60 μm without using a light diffusion control layer and an intermediate pressure sensitive adhesive, and a reflective display body sample was also obtained.

### Comparative Example 2

A light diffusion control member was manufactured in the same manner as in Example 1, except that the light diffusion control layer and the intermediate pressure sensitive adhesive layer were laminated to form a light diffusion control member without using a diffusion pressure sensitive adhesive layer, and a reflective display body sample was also obtained.

Table 3 also lists the haze value (%) of the diffusion pressure sensitive adhesive layer used in each of the examples and comparative examples.

### <Testing Example 1> (Measurement of Luminance and Standard Deviation)

### (1) Calculation of Standard Deviation and Determination of Exclusion Angle

As illustrated in FIG. 6(b), for the reflective display body samples manufactured in the examples and comparative Examples, a point on the surface (irradiated surface) on the light diffusion control member side was assumed as the irradiation point (point 201 in FIG. 6(b)), and four directions of azimuth angles of 0°, 90°, 180°, and 270° with respect to the irradiation point as the center were also assumed. At that time, the direction C in FIG. 5 of the light diffusion control layer in the light diffusion control member 1 was set to coincide with the azimuth angle of 270°.

Subsequently, a reflective display body sample 200 was installed in a conoscope (available from Autronic Melcher). In its reflection mode, the above irradiation point was irradiated with a light ray from a direction of an azimuth angle of 0°, and the luminance distribution of the diffused and reflected light was measured. At that time, as illustrated in FIG. 6(c), the irradiation was performed so that the angle between the light ray 202 and the normal to the above surface of the reflective display body sample 200 would be 30°.

Then, as illustrated in FIG. 7(b), a plane (plane P in FIG. 7(b)) was assumed that includes the irradiation point 201 and the normal to the irradiation surface and is perpendicular to the azimuth angle of 0° (i.e., parallel to the azimuth angles of 90° and) 270°. The luminance of the reflected light traveling within the plane and making an angle of 30° or less with the normal to the above irradiation surface was read from the above luminance distribution, and the standard deviation (cd/m²) of the luminance for an azimuth angle of 0° was calculated. The results are listed in Table 2.

Furthermore, also for the cases in which light rays were emitted from azimuth angles of 90°, 180°, and 270°, a plane was assumed in the same manner as above, and the standard deviations (cd/m²) of the luminance for azimuth angles of 90°, 180°, and 270° were calculated. The results are listed in Table 2.

Among the standard deviations of the luminance for the four azimuth angles obtained as above, the one with the largest value was identified, and the azimuth angle that gave that standard deviation was determined as the exclusion angle. The exclusion angle is listed in Table 2.

### (2) Measurement of Luminance in Front Direction

In the same manner as in the above step (1), the reflective display body sample was irradiated with a light ray for each of the four azimuth angles, and the luminance distribution of the diffused and reflected light was measured. Then, from the luminance distributions obtained for the four azimuth angles, the luminance (cd/m²) of the reflected light (light ray indicated by reference numeral 203 in FIG. 7(a)) reflected in the front direction (direction parallel to the normal to one surface of the above reflective display body sample) was read. The results are listed in Table 3. Note, however, that Table 3 lists the luminance for the exclusion angle identified in the above step (1) with a strikethrough.

Furthermore, among the luminance values for the three azimuth angles excluding the exclusion angle, the minimum luminance was defined as Lₘᵢₙ, and the maximum luminance was defined as Lₘₐₓ. These are listed in Table 3.

In addition, the reflective display body sample was changed to a standard white plate (available from Labsphere, product name “SRS-99-010”), and the luminance distribution was measured in the same manner as above for the same azimuth angle as the azimuth angle at which the above Lₘᵢₙ was given. Then, from the luminance distribution, the luminance of the light reflected in the front direction was read and defined as L_{STD}. The results are listed in Table 3.

(3) Calculation of L₁, L₂, and L₃

Using the values of Lₘᵢₙ, Lₘₐₓ, and L_{STD} identified/measured in the above step (2), L₁ and L₂ were calculated from the equations:

$$L 1 = {L}_{min} / {L}_{STD} ; \\ and \\ L 2 = {L}_{min} / {L}_{max} .$$

These values are listed in Table 3.

Furthermore, among the four standard deviations obtained in the above step (1), the standard deviations for the three azimuth angles excluding the above exclusion angle were defined as L₃. Values of L₃ are listed in Table 3. Table 3 lists the standard deviation for the exclusion angle with a strikethrough.

### <Testing Example 2> (Evaluation of Optical Performance)

The reflective display body samples manufactured in the examples and comparative examples were held in the hands under sunlight on a sunny day and in an indoor environment with multiple lights installed, and when the viewing direction and angle of the reflective display body sample were changed or rotated, the samples were evaluated based on the following criteria to check whether there was any problem with visibility due to a sudden change in brightness or a difference in brightness within the surface in a state equivalent to white display. The results are listed in Table 4. The brightness of each environment was measured using an illuminometer (available from HIOKI E.E. CORPORATION, product name “3423 LUX HiTESTER”), and it was 105,000 lx under sunlight and 780 lx under multiple indoor lights.
∘: The change in brightness was small when the viewing angle was changed or rotated.
x: The change in brightness was large when the viewing angle was changed or rotated.

### <Testing Example 3> (Evaluation of Backscattering Properties)

The tight release sheet 2 was removed from the light diffusion control member manufactured in each of the examples and comparative examples, and the exposed surface of the diffusion pressure sensitive adhesive layer was attached to one surface of a black plate (thickness 2 mm) made of polymethyl methacrylate. Subsequently, the release sheet laminated on the light diffusion control layer A was removed, and a sample for measurement was thus obtained.

For the light diffusion control member of Example 9, the exposed surface of the intermediate pressure sensitive adhesive layer exposed by removing the tight release sheet 1 was attached to the above black plate to prepare a sample for measurement. For the light diffusion control member of Comparative Example 1, the exposed surface of the diffusion pressure sensitive adhesive layer exposed by removing the easy release sheet 2 was attached to the above black plate to prepare a sample for measurement. For the light diffusion control member of Comparative Example 2, the surface of the intermediate pressure sensitive adhesive layer opposite to the light diffusion control layer was attached to the above black plate to prepare a sample for measurement.

The samples for measurement obtained as described above were visually observed under fluorescent light to confirm the color of the black plate as seen through the light diffusion control member. Then, the backscattering properties were evaluated based on the following criteria. The results are listed in Table 4.
∘: Black color with no whitish tinge.
x: Black color with a whitish tinge.

If there is back scattering, the black of the black plate will be hazy and the black will be seen as whitish. In other words, an increase in black luminance leads to a decrease in the contrast ratio calculated from the white luminance and black luminance.

### <Testing Example 4> (Evaluation of Durability)

In the same manner as described in step (1) of the aforementioned <Example 1>, a laminate was prepared in which the tight release sheet 1, the intermediate pressure sensitive adhesive layer having a thickness of 15 μm (referred to as a “pressure sensitive adhesive layer for fixation,” hereinafter, to distinguish it from the intermediate pressure sensitive adhesive layer in the reflective display body sample), and the easy release sheet 1 were laminated in this order. Then, the easy release sheet 1 was removed from the laminate, and the exposed pressure sensitive adhesive layer for fixation was attached to one surface of a polyethylene terephthalate film (available from Mitsubishi Chemical Corporation, product name “Diafoil T600E,” thickness: 38 μm) provided with an easy-adhesion surface on one surface. Subsequently, the tight release sheet 1 was removed, and the exposed pressure sensitive adhesive layer for fixation was attached to the surface of the reflective display body sample, manufactured in each of the examples and comparative examples, on the light diffusion control layer side to prepare a sample for durability evaluation. Such samples were subjected to durability test 1 in which they were stored in a high-temperature environment of 85° C. for 500 hours and durability test 2 in which they were stored in a high-temperature and high-humidity condition of 60° C. and 90% RH for 500 hours.

After that, the reflective display body sample was taken out from each environment, and the conditions at the interface between the light diffusion control layer and the intermediate pressure sensitive adhesive layer, the interface between the intermediate pressure sensitive adhesive layer and the diffusion pressure sensitive adhesive layer, and the interface between the diffusion pressure sensitive adhesive layer and the mirror were visually confirmed. The durability was evaluated in accordance with the following criteria. The results are listed in Table 4.
∘: No air bubbles, floating, or delamination occurred at any of the interfaces.
x: Air bubbles, floating, or delamination occurred at any of the interfaces.

TABLE 1

| | | | Angle (angle “a”) | | | |
|---|---|---|---|---|---|---|
| | | | between extending | | | |
| | | Irradiation | direction of columnar | | | |
| | | angle of UV | bodies and thickness | | | |
| | | ray during | direction of light | | Layer | Thickness |
| | | formation (°) | diffusion control layer | Bending | configuration | (μm) |
| Light diffusion control layer A | | 5 | 3.2 | Present | 1 layer | 110 |
| Light diffusion control layer B | | 5 | 3.2 | Present | 1 layer | 60 |
| Light diffusion control layer C | | 10 | 6.4 | Present | 1 layer | 110 |
| Light diffusion | Upper layer | 0 | 0 | Absent | 2 layers | 200 |
| control layer D | Lower layer | 10 | 6.4 | Present | | |

| | | | | | |
|---|---|---|---|---|---|
| Light diffusion control layer E | 20 | 12.7 | Present | 1 layer | 110 |
| Light diffusion control layer F | 15 | 9.6 | Absent | 1 layer | 120 |

TABLE 2

| | Standard deviation of luminance | | | | |
|---|---|---|---|---|---|
| | for each azimuth angle (cd/m²) | | | | Exclusion |
| | 0° | 90° | 180° | 270° | angle |
| Example 1 | 0.84 | 1.27 | 0.23 | 0.88 | 90° |
| Example 2 | 0.68 | 1.42 | 0.16 | 1.02 | 90° |
| Example 3 | 0.68 | 1.42 | 0.16 | 1.02 | 90° |
| Example 4 | 0.43 | 0.99 | 0.19 | 0.69 | 90° |
| Example 5 | 0.40 | 0.66 | 0.22 | 0.61 | 90° |
| Example 6 | 0.42 | 1.30 | 0.32 | 0.50 | 90° |
| Example 7 | 0.31 | 2.39 | 0.44 | 0.35 | 90° |
| Example 8 | 0.22 | 1.31 | 0.32 | 0.20 | 90° |
| Example 9 | 0.37 | 0.49 | 0.37 | 0.85 | 270° |
| Comparative Example 1 | 1.13 | 1.13 | 1.06 | 1.08 | 0° |
| Comparative Example 2 | 0.99 | 2.23 | 0.41 | 1.34 | 90° |
| Comparative Example 3 | 0.42 | 1.27 | 0.30 | 1.08 | 90° |
| Comparative Example 4 | 0.98 | 1.08 | 0.74 | 0.40 | 90° |
| Comparative Example 5 | 0.26 | 1.70 | 0.28 | 0.45 | 90° |

TABLE 3

| | | Intermediate | Diffusion pressure | | | | |
|---|---|---|---|---|---|---|---|
| | Light | pressure | sensitive adhesive layer | | | | |
| | diffusion | sensitive | | | Haze | Luminance in front | |
| | control | adhesive | Light-diffusing | Thickness | value | direction (cd/m²) | |
| | layer | layer | fine particles | (μm) | (%) | 0° | 90° |
| Example 1 | A | Present | Silicone resin | 40 | 74 | 8.71 | [symbol] |
| Example 2 | A | Present | Silicone resin | 45 | 87 | 8.27 | [symbol] |
| Example 3 | A | — | Silicone resin | 45 | 87 | 8.27 | [symbol] |
| Example 4 | A | Present | Silicone resin | 50 | 92 | 7.42 | [symbol] |
| Example 5 | A | Present | Titanium oxide | 25 | 34 | 5.55 | [symbol] |
| Example 6 | B | Present | Silicone resin | 50 | 92 | 6.62 | [symbol] |
| Example 7 | C | Present | Silicone resin | 50 | 87 | 5.93 | [symbol] |
| Example 8 | D | Present | Silicone resin | 45 | 87 | 6.42 | [symbol] |
| Example 9 | A | Present | Silicone resin | 45 | 87 | 7.39 | 8.062 |
| Comparative | — | — | Silicone resin | 80 | 95 | [symbol] | 6.27 |
| Example 1 | | | | | | | |
| Comparative | A | Present | — | — | — | 9.85 | [symbol] |
| Example 2 | | | | | | | |
| Comparative | A | Present | Silicone resin | 25 | 50 | 8.52 | [symbol] |
| Example 3 | | | | | | | |
| Comparative | E | Present | Silicone resin | 50 | 92 | 5.33 | [symbol] |
| Example 4 | | | | | | | |
| Comparative | F | Present | Silicone resin | 50 | 92 | 5.03 | [symbol] |
| Example 5 | | | | | | | |

| | Luminance in | | | | | | | | | | |
|---|---|---|---|---|---|---|---|---|---|---|---|
| | front direction | | | | | | | | | | |
| | (cd/m²) | | | | | | | L [symbol] | | | |
| | 180° | 270° | L [symbol] | L [symbol] | L [symbol] | L₁ | L [symbol] | 0° | 90° | 180° | 270° |
| Example 1 | [symbol] .72 | 10.42 | 7.72 | 10.42 | 5.03 | 1.53 | 0.74 | 0.84 | [symbol] | 0.23 | 0.88 |
| Example 2 | [symbol] | 10.18 | 7.45 | 10.18 | 5.03 | 1. [symbol] | 0. [symbol] | [symbol] | [symbol] | 0.1 [symbol] | 1.02 |
| Example 3 | [symbol] | 10.18 | 7.45 | 10.18 | 5.03 | 1. [symbol] | 0. [symbol] | [symbol] | [symbol] | 0.18 | 1.02 |
| Example 4 | [symbol] | [symbol] .14 | 7.10 | 9.14 | 5.03 | 1. [symbol] | 0. [symbol] | [symbol] | [symbol] | 0.1 [symbol] | 0.69 |
| Example 5 | [symbol] | 6.92 | 5.19 | 6.92 | 4.80 | [symbol] | [symbol] | [symbol] | [symbol] | 0.22 | 0.61 |
| Example 6 | [symbol] | 7.25 | 5.85 | 7.25 | 4.80 | [symbol] | [symbol] | [symbol] | [symbol] | 0.32 | 0.5 [symbol] |
| Example 7 | [symbol] | 5.74 | 5.74 | 6.18 | 4.75 | [symbol] | [symbol] | [symbol] | [symbol] | 0.44 | 0.35 |
| Example 8 | [symbol] | 6.63 | 6. [symbol] 2 | 6.74 | 4.80 | [symbol] | [symbol] | [symbol] | [symbol] | 0.32 | 0.20 |
| Example 9 | 7.24 | [symbol] | [symbol] | [symbol] | [symbol] .34 | 1.4 | 0. [symbol] | 0.37 | 0.48 | 0.37 | [symbol] |
| Comparative | [symbol] .03 | 6.14 | 8.03 | [symbol] | [symbol] | [symbol] | [symbol] | [symbol] | 1.13 | 1.08 | 1.08 |
| Example 1 | | | | | | | | | | | |
| Comparative | [symbol] | 12.94 | 8. [symbol] | 12. [symbol] 4 | [symbol] .0 [symbol] | [symbol] | [symbol] | [symbol] | [symbol] | 0.41 | 1.34 |
| Example 2 | | | | | | | | | | | |
| Comparative | [symbol] | 12.00 | 8.23 | 12.00 | [symbol] .0 [symbol] | [symbol] | [symbol] | [symbol] | [symbol] | 0.30 | 1.08 |
| Example 3 | | | | | | | | | | | |
| Comparative | [symbol] | 3.50 | 3.50 | 5.61 | 4.80 | [symbol] | [symbol] | [symbol] | [symbol] | 0.74 | 0.40 |
| Example 4 | | | | | | | | | | | |
| Comparative | [symbol] | 4.7 [symbol] | 4.7 [symbol] | 5.39 | 4.80 | 0. [symbol] | 0.88 | 0.28 | [symbol] | 0.25 | 0.45 |
| Example 5 | | | | | | | | | | | |

[symbol]

indicates data missing or illegible when filed

TABLE 4

| | Optical performance | | | | |
|---|---|---|---|---|---|
| | | Under | | | |
| | | multiple | Back- | Durability | |
| | Under | indoor | scattering | | 60° C. |
| | sunlight | lights | properties | 85° C. | 90% RH |
| Example 1 | ◯ | ◯ | ◯ | ◯ | ◯ |
| Example 2 | ◯ | ◯ | ◯ | ◯ | ◯ |
| Example 3 | ◯ | ◯ | ◯ | X | X |
| Example 4 | ◯ | ◯ | ◯ | ◯ | ◯ |
| Example 5 | ◯ | ◯ | X | ◯ | ◯ |
| Example 6 | ◯ | ◯ | ◯ | ◯ | ◯ |
| Example 7 | ◯ | ◯ | ◯ | ◯ | ◯ |
| Example 8 | ◯ | ◯ | ◯ | ◯ | ◯ |
| Example 9 | ◯ | ◯ | ◯ | ◯ | ◯ |
| Comparative | X | X | ◯ | — | — |
| Example 1 | | | | | |
| Comparative | X | X | ◯ | — | — |
| Example 2 | | | | | |
| Comparative | X | X | ◯ | ◯ | ◯ |
| Example 3 | | | | | |
| Comparative | X | X | ◯ | ◯ | ◯ |
| Example 4 | | | | | |
| Comparative | X | X | ◯ | ◯ | ◯ |
| Example 5 | | | | | |

From Table 4, it has been found that reflective excellent visibility can be display bodies having manufactured by using the light diffusion control members according to the examples. In particular, the results have been such that the light diffusion control members according to Examples 1 to 9 have excellent visibility in both outdoor and indoor environments, while the light diffusion control members according to Comparative Examples 1 to 5 have poor visibility. In particular, the light diffusion control members according to the comparative examples had significant changes in luminance when the reflective display body samples were rotated or tilted slightly, and were not suitable for use as reflective display bodies. It has also been found that the light diffusion control members according to Examples 1 to 4 and 6 to 9 can effectively suppress backscattering. Furthermore, it has also been found that the light diffusion control members according to Examples 1, 2, and 4 to 9 have excellent durability.

### INDUSTRIAL APPLICABILITY

The light diffusion control member of the present invention is suitably used for the production of a display body configured such that the up-down direction of the display content can be changed.

### DESCRIPTION OF REFERENCE NUMERALS

1a, 1b . . . Light diffusion control member
   11 . . . Light diffusion control layer
   12 . . . Diffusion pressure sensitive adhesive layer
   13 . . . Intermediate pressure sensitive adhesive layer
   111 . . . Regions having relatively high refractive index (columnar bodies)
   112 . . . Region having relatively low refractive index
2 . . . Display device
3 . . . Reflective layer
4 . . . Mirror
100 . . . Reflective display body
200 . . . Sample for measurement
201 . . . Irradiation point
202 . . . Light ray
203, 204a, 204b . . . Reflected light

1. A light diffusion control member comprising:
a light diffusion control layer having a regular internal structure that includes a plurality of regions having a relatively high refractive index in a region having a relatively low refractive index; and
a diffusion pressure sensitive adhesive layer that is laminated on one surface side of the light diffusion control layer and contains light-diffusing fine particles,
wherein, provided that:
an arbitrary point on a surface on the light diffusion control member side of a measurement sample obtained by laminating an arbitrary surface of the light diffusion control member on a reflective surface of an arbitrary mirror is irradiated with a light ray having an angle of 30° with respect to a normal to the surface from each of four directions of azimuth angles of 0°, 90°, 180°, and 270° with the point as a center to generate reflected light that is diffused and reflected from the point for each of the azimuth angles, for the reflected light that travels within a plane including the point and the normal and forms an angle of 30° or less with the normal, a value of a standard deviation (cd/m²) of luminance is calculated for each of the azimuth angles, and the azimuth angle that gives a largest standard deviation is as defined an exclusion angle;
an arbitrary point on the surface on the light diffusion control member side of the measurement sample is irradiated with a light ray having an angle of 30° with respect to the normal to the surface from each of three directions of azimuth angles excluding the exclusion angle out of the four directions of azimuth angles to generate reflected light that is diffused and reflected from the point for each of the three directions of azimuth angles, luminance (cd/m²) of the reflected light that travels in a front direction of the surface is measured for each of the three directions of azimuth angles, and a minimum luminance value of the three obtained luminance values is defined as Lₘᵢₙ while a maximum luminance value is defined as Lₘₐₓ; and
an arbitrary point on one surface of any standard white plate is irradiated with a light ray having an angle of 30° with respect to the normal from the azimuth angle, at which the Lₘᵢₙ is measured, to generate reflected light that is diffused and reflected from the point in the front direction, and a value luminance (cd/m²) of the of reflected light is defined as L_{STD},
L₁ represented by L₁=Lₘᵢₙ/L_{STD} satisfies Expression (1) below
$${L}_{1} > 1. , \qquad ( 1 )$$
L₂ represented by L₂=Lₘᵢₙ/Lₘₐₓ satisfies Expression (2) below
$$0.7 \leq {L}_{2} \leq 1. , \qquad ( 2 )$$
when values of standard deviations (cd/m²) relating to the three directions of azimuth angles excluding the exclusion angle out of the four directions of azimuth angles are L₃, L₃ in all the three directions satisfies Expression (3) below
$${L}_{3} < 2 \text{.00} . \qquad ( 3 )$$

2. The light diffusion control member according to claim 1, wherein
the regions having a relatively high refractive index are columnar bodies extending from one surface side to another surface side of the light diffusion control layer,
the light diffusion control layer includes at least one layer formed of a column structure configured such that the columnar bodies are densely arranged to stand in the region having a relatively low refractive index, and
a straight line parallel to a direction of the extension is tilted with respect to a thickness direction of the light diffusion control layer in at least some of the columnar bodies.

3. The light diffusion control member according to claim 2, wherein the columnar bodies are bent between one end and another end in at least one layer formed of the column structure.

4. The light diffusion control member according to claim 2, wherein the light diffusion control layer includes two layers each formed of the column structure.

5. The light diffusion control member according to claim 1, wherein
the light diffusion control layer includes an intermediate pressure sensitive adhesive layer laminated between the light diffusion control layer and the diffusion pressure sensitive adhesive layer, and
the intermediate pressure sensitive adhesive layer is composed of a pressure sensitive adhesive containing a carboxy group.

6. The light diffusion control member according to claim 1, wherein the light-diffusing fine particles are fine particles composed of a silicon-containing compound having an intermediate structure between inorganic one and organic one.

7. A reflective display body configured such that an up-down direction of a display content on a display surface can be changed, the reflective display body comprising:
the light diffusion control member according to claim 1;
a display device provided on any one surface side of the light diffusion control member; and
a reflective layer that is provided on a surface side of the display device opposite to the light diffusion control member or that is incorporated in the display device.
